(19) United States
(12) Patent Application Publication
(10) Pub. No.: US 2012/0112048 A1
(43) Pub. Date: May 10, 2012

(54) COMPOSITE OPTICAL ELEMENT AND OPTICAL HEAD DEVICE

(75) Inventors: Koji MIYASAKA, Fukushima (JP); Takuji NOMURA, Fukushima (JP); Kensuke ONO, Fukushima (JP)

(73) Assignee: Asahi Glass Company, Limited, Tokyo (JP)

(21) Appl. No.: 13/344,953

(22) Filed: Jan. 6, 2012

Related U.S. Application Data
(63) Continuation of application No. PCT/JP2010/061491, filed on Jul. 6, 2010.

(30) Foreign Application Priority Data
Jul. 10, 2009 (JP) 2009-164240

(51) Int. Cl. G02B 5/18; H01J 40/14

(52) U.S. Cl. 250/216; 359/566

(57) ABSTRACT

A composite optical element includes: a single lens; a first resin layer formed on a surface of the single lens; a second resin layer formed on the first resin layer, wherein: the first resin layer has a diffraction grating of a Fresnel lens configuration; and a refractive index of the first resin layer and that of the second layer are substantially the same value for at least a light beam of one of a light beam of a wavelength λ₁, a light beam of a wavelength λ₂ and a light beam of a wavelength λ₃ (λ₁<λ₂<λ₃), and the refractive index of the first resin layer and that of the second resin layer are different values for at least a light beam of another one of the light beam of the wavelength λ₁, the light beam of the wavelength λ₂ and the light beam of the wavelength λ₃.

### TECHNICAL FIELD

The present invention relates to a composite optical element and an optical head device, and more particularly, relates to a composite optical element and an optical head device used for information recording media of different wavelengths.

### BACKGROUND ART

As optical disks, Blu-ray (product name, hereinafter, referred to as BD), the DVD and the CD are widely prevalent. These BD, DVD and CD are different from one another in the wavelength of the light beam used for recording and reading, and the like. Specifically, in the case of the BD, a light beam emitted from a light source of a wavelength of 405 nm is focused on an information recording medium with a substrate thickness (cover layer thickness) of 0.1 mm by an objective lens with an NA (numerical aperture) of 0.85 to thereby perform recording and reading of information. In the case of the DVD, a light beam emitted from a light source of a wavelength of 660 nm is focused on an information recording medium with a substrate thickness (cover layer thickness) of 0.6 mm by an objective lens with an NA of 0.65 to thereby perform recording and reading of information. In the case of the CD, a light beam emitted from a light source of a wavelength of 780 nm is focused on an information recording medium with a substrate thickness (cover layer thickness) of 1.2 mm by an objective lens with an NA of 0.45 to thereby perform recording and reading of information.

When it is considered to focus the light beams of the wavelengths used for the optical disks by one objective lens on the optical discs in the above-described BD, DVD and CD, it is necessary that the spherical aberration caused by the difference in cover layer thickness among the optical discs can be corrected and that excellent characteristics of focusing on each optical disc be obtained. In addition, to prevent the objective lens that moves parallel to the direction of the optical axis of each light beam from being in contact with the surface of the optical disc, it is necessary that excellent characteristics of focusing on each optical disc be obtained while a fixed distance is secured between the objective lens and the optical disc.

To deal with this, a method is available in which the divergence angle is adjusted for the light beam of each wavelength incident on the objective lens. FIGS. 1A and 1B are views each schematically showing an example of an optical system employing this method. FIG. 1A shows an optical system for the BD. FIG. 1B shows an optical system for the CD. For example, as shown in FIG. 1A, in the optical system for the BD, an objective lens 201 is set at a φ of 3 mm and an NA of 0.85, the distance WD1 between the objective lens 201 and an optical disc (BD) 202 is set to 0.7 mm, and a light beam 203 of a wavelength for the BD is made incident with an infinite system (divergence angle 0°) and is focused on an information recording surface 202b of the optical disc 202 where the thickness of a cover layer 202a is 0.1 mm.

On the other hand, when it is intended to handle an optical disc (CD) 212 by using the same objective lens 201, by making a light beam 214 of a wavelength for the CD incident as a divergent light beam on the objective lens 201 from a light source 213, the light beam 214 can be focused on an information recording surface 212b of the optical disc (CD) 212 where the thickness of the cover layer 212a is 1.2 mm in a condition where the spherical aberration can be corrected. However, when it is intended to secure, for example, 0.3 mm as the distance WD2 between the objective lens 201 and the optical disc (CD) 212 in the optical disc (CD) 212, since the distance L between the light source 213 and the objective lens 201 is as short as approximately 15 mm, it is difficult to dispose other optical parts on the optical path between the light source 213 and the optical disc (CD) 212. In addition, since the focal lengths of the light beams reflected at the BD and the CD are different from each other, it is necessary to provide a photodetector that detects these light beams in each optical system, so that a signal processing circuit that performs recording and reading of the optical discs becomes complicated.

As a method to deal with such a problem, Patent Document 1 discloses an optical pickup device that performs recording and reading of information onto and from the optical discs of three different standards by using one diffractive optical element by disposing a diffractive optical element that exhibits a diffraction action on the light beam of each of the wavelengths for the DVD and the CD, in the optical system so as to have the function as an objective lens also for the light beams of the wavelengths.

### PRIOR ART DOCUMENT

### Patent Document

Patent Document 1: Japanese Patent No. 3966303

### SUMMARY OF THE INVENTION

### Problems to be Solved by the Invention

According to a method disclosed in Patent Document 1, since a diffraction action can be independently applied to the light beam of each of the wavelengths for the DVD and the CD, the divergence angle can be made an angle suitable for the light beam of each of the wavelengths and a phase distribution that corrects the spherical aberration can be further added, so that the light beam can be focused suitably for the optical discs of three kinds of standards among which the wavelength of the light beam used for recording and reading is different, while the distance between the objective lens and the optical disc in the optical system for the CD is ensured.

In the method disclosed in Patent Document 1, since it is necessary that the diffractive optical element be placed separately from the objective lens and be precisely aligned with respect to the objective lens and the like, mass productivity is low. In addition, since a binary grating the cross section of which is rectangular is used for diffracting the light beam for the CD and for this reason, only one of the plus/minus 1st order diffracted light beams is used, the utilization efficiency of light is low.

The present invention is made in view of the above-described points, and an object thereof is to provide a composite optical element and an optical head device where it is unnecessary to perform position adjustment, light use efficiency is high and it is possible to suitably focus light beams on optical discs of different standards.

### Means for Solving the Problem

The present invention provides a composite optical element provided with: a single lens having a curved surface shape and acting optically; a first resin layer formed on a surface of the single lens; a second resin layer formed on the first resin layer, wherein: the first resin layer has a diffraction grating of a Fresnel lens configuration on a side of the second resin layer; and a refractive index of the first resin layer and a refractive index of the second layer are substantially the same value for at least a light beam of one of a light beam of a wavelength λ₁, a light beam of a wavelength λ₂ and a light beam of a wavelength λ₃ (λ₁<λ₂<λ₃), and the refractive index of the first resin layer and the refractive index of the second resin layer are different values for at least a light beam of another one of the light beam of the wavelength the light beam of the wavelength λ₂ and the light beam of the wavelength λ₃.

The second resin layer may have a diffraction grating of a Fresnel lens configuration on a surface on a side facing a side of the first resin layer.

The diffraction grating formed on the surface of the second resin layer on the side facing the side of the first resin layer may have a step-like pseudo blaze configuration where the blaze configuration is approximated to a plurality of level differences, and the level differences may provide a phase difference which is substantially an integral multiple of one kind of the three kinds of wavelengths of the light beams or provide a phase difference which is substantially an integral multiple at two kinds of the three kinds of wavelengths of the light beams.

The second resin layer may have a central region with a center at an optical axis and an annular peripheral region surrounding the central region on the surface on the side facing the side of the first resin layer, the central region may have a curved surface shape, and the peripheral region may have a phase level difference or a binary diffraction grating for a curved surface of the central region.

The peripheral region may have the phase level difference; the phase level difference may have a plurality of level differences; and the level differences may provide a phase difference which is substantially an integral multiple of one kind of the three kinds of wavelengths of the light beams or provide a phase difference which is substantially an integral multiple of each of two kinds of the three kinds of wavelengths of the light beams.

The peripheral region may have the phase level difference; the phase level difference may consist of one level difference; and the level difference may provide a phase difference substantially equal to an odd multiple of λ₃/2 for the light beam of the wavelength λ₃ and provide a phase difference substantially equal to substantially an integral multiple at each wavelength for the light beam of the wavelength λ₁ and the light beam of the wavelength λ₂.

The peripheral region may have the binary diffraction grating; and a depth of the binary diffraction grating may be a value that provides a phase difference substantially equal to an odd multiple of λ₃/2 for the light beam of the wavelength λ₃ and provides a phase difference substantially equal to an integral multiple of each wavelength for the light beam of the wavelength λ₁ and the light beam of the wavelength λ₂.

The first resin layer may have an inner central region with a center at an optical axis and an annular inner peripheral region surrounding the inner central region on the side of the second resin layer, the inner central region may have the diffraction grating of the Fresnel lens configuration, and the inner peripheral region may have a curved surface shape.

A protective layer may be formed on the second resin layer.

The wavelength λ₁ may be a 405-nm wavelength band of 375 to 435 nm, the wavelength λ₂ may be a 660-nm wavelength band of 630 to 690 nm, and the wavelength λ₃ may be a 780-nm wavelength band of 750 to 810 nm.

Moreover, the present invention provides an optical head device provided with: a light source that emits a light beam of a 405-nm wavelength band, a light beam of a 660-nm wavelength band and a light beam of a 780-nm wavelength band; the above-described composite optical element that focuses the light beam of each of the wavelength bands emitted from the light source, on an information recording surface of an optical disc conforming to the light beam of the wavelength band; and a photodetector for detecting a signal light beam reflected at the information recording surface of the optical disc.

### Effects of the Invention

According to the present invention, a composite optical element and an optical head device can be provided where it is unnecessary to perform position adjustment of a diffractive optical element and the like, utilization efficiency of the light is high and it is possible to suitably focus light beams on optical discs of different standards.

### BRIEF DESCRIPTION OF THE DRAWINGS

FIG. 1A is an explanatory view of the conventional optical system that focuses light beams on different optical discs by using the common objective lens.

FIG. 1B is an explanatory view of the conventional optical system that focuses light beams on different optical discs by using the common objective lens.

FIG. 2 is a cross-sectional view of a composite optical element according to a first embodiment.

FIG. 3 is a front view of the composite optical element according to the first embodiment.

FIG. 4 is a correlation chart of the wavelength and the refractive index at a first resin layer and a second resin layer in the first embodiment.

FIG. 5 is a cross-sectional view of a composite optical element according to a second embodiment.

FIG. 6 is a front view of the composite optical element according to the second embodiment.

FIG. 7A is an explanatory view of the composite optical element according to the second embodiment.

FIG. 7B is an explanatory view of the composite optical element according to the second embodiment.

FIG. 8 is a cross-sectional view of a composite optical element according to a third embodiment.

FIG. 9 is a cross-sectional view of a composite optical element according to a fourth embodiment.

FIG. 10 is a cross-sectional view of a composite optical element according to a fifth embodiment.

FIG. 11 is a cross-sectional view of a composite optical element according to a sixth embodiment.

FIG. 12 is a cross-sectional view of a composite optical element according to a seventh embodiment.

FIG. 13 is a correlation chart of the wavelength and the refractive index at a first resin layer and a second resin layer in the seventh embodiment.

FIG. 14 is a cross-sectional view of a composite optical element according to an eighth embodiment.

FIG. 15 is a cross-sectional view of a composite optical element according to a ninth embodiment.

FIG. 16 is a configuration diagram of an optical head device according to a tenth embodiment.

FIG. 17 is a configuration diagram of an optical head device according to an eleventh embodiment.

FIG. 18 is a correlation chart of the wavelength and the diffraction efficiency in Example 1.

FIG. 19 is a correlation chart of the wavelength and the diffraction efficiency in Example 1.

FIG. 20 is an explanatory view of an optical position relationship from a virtual light source to an optical disc.

FIG. 21A is a graphic representation of aberration of a light beam with a wavelength of 405 nm in Example 1.

FIG. 21B is a graphic representation of aberration of a light beam with a wavelength of 660 nm in Example 1.

FIG. 21C is a graphic representation of aberration of a light beam with a wavelength of 780 nm in Example 1.

FIG. 22A is a graphic representation of aberration of a light beam with a wavelength of 405 nm in Example 2.

FIG. 22B is a graphic representation of aberration of a light beam with a wavelength of 660 nm in Example 2.

FIG. 22C is a graphic representation of aberration of a light beam with a wavelength of 780 nm in Example 2.

FIG. 23A is a graphic representation of aberration of a light beam with a wavelength of 405 nm in Example 3.

FIG. 23B is a graphic representation of aberration of a light beam with a wavelength of 660 nm in Example 3.

FIG. 23C is a graphic representation of aberration of a light beam with a wavelength of 780 nm in Example 3.

FIG. 24A is a graphic representation of aberration of a light beam with a wavelength of 405 nm in Example 4.

FIG. 24B is a graphic representation of aberration of a light beam with a wavelength of 660 nm in Example 4.

FIG. 24C is a graphic representation of aberration of a light beam with a wavelength of 780 nm in Example 4.

FIG. 25A is a graphic representation of aberration of a light beam with a wavelength of 405 nm in Example 5.

FIG. 25B is a graphic representation of aberration of a light beam with a wavelength of 660 nm in Example 5.

FIG. 25C is a graphic representation of aberration of a light beam with a wavelength of 780 nm in Example 5.

FIG. 26A is a graphic representation of aberration of a light beam with a wavelength of 405 nm in Example 8.

FIG. 26B is a graphic representation of aberration of a light beam with a wavelength of 660 nm in Example 8.

FIG. 26C is a graphic representation of aberration of a light beam with a wavelength of 780 nm in Example 8.

FIG. 27A is a graphic representation of aberration of a light beam with a wavelength of 405 nm in Example 9.

FIG. 27B is a graphic representation of aberration of a light beam with a wavelength of 660 nm in Example 9.

FIG. 27C is a graphic representation of aberration of a light beam with a wavelength of 780 nm in Example 9.

FIG. 28A is a graphic representation of aberration of a light beam with a wavelength of 405 nm in Example 10.

FIG. 28B is a graphic representation of aberration of a light beam with a wavelength of 660 nm in Example 10.

FIG. 28C is a graphic representation of aberration of a light beam with a wavelength of 780 nm in Example 10.

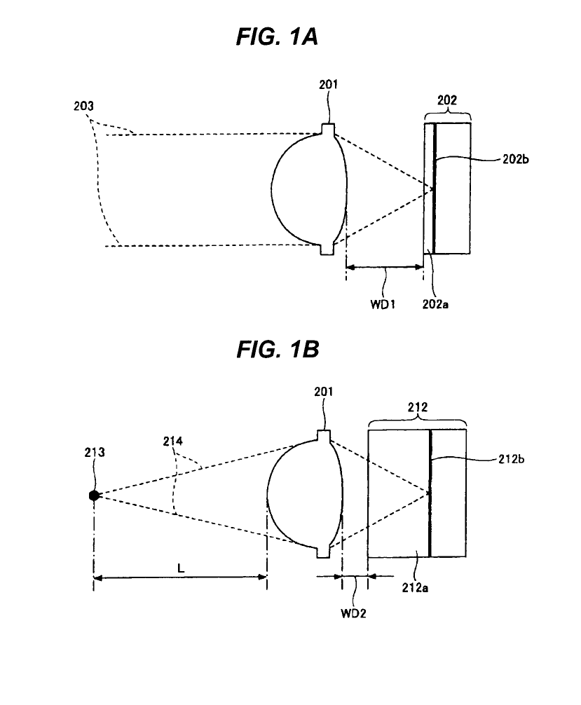

### MODES FOR CARRYING OUT THE INVENTION

Modes for carrying out the invention will be described below.

### First Embodiment

A first embodiment will be described. The present embodiment is a composite optical element of a structure including a single lens having an objective lens configuration.

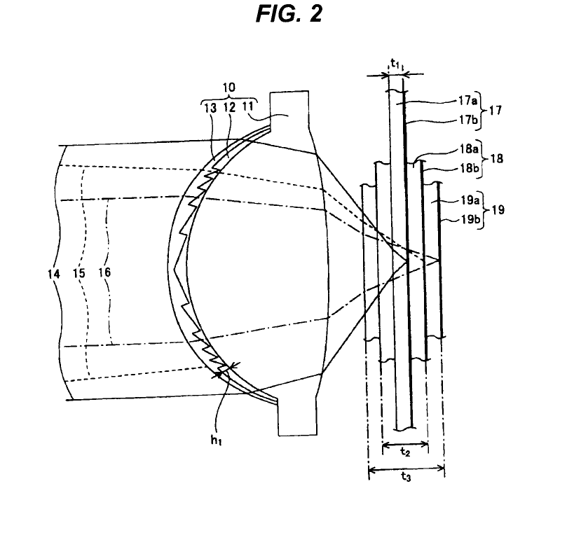

Based on FIG. 2, the composite optical element according to the present embodiment will be described. FIG. 2 is a view schematically showing the composite optical element according to the present invention and three kinds of optical discs. In the composite optical element 10 according to the present embodiment, a first resin layer 12 is formed on the surface of a single lens 11, a second resin layer 13 is formed on the surface of the first resin layer 12, and these are integrated with one another. An optical head device of a structure including the composite optical element 10 is structured so that three kinds of light beams of different wavelengths, that is, a light beam 14 of a wavelength λ₄, a light beam 15 of a wavelength λ₂ and a light beam 16 of a wavelength λ₃ can be incident from a non-illustrated light source through an optical system or the like as required, and the light beams are focused on their respective kinds of optical discs through the composite optical element 10 according to the present embodiment.

The three kinds of optical discs are a first optical disc 17 formed of a cover layer 17a with a thickness t₁ and an information recording surface 17b, a second optical disc 18 formed of a cover layer 18a with a thickness t₂ and an information recording surface 18b, and a third optical disc 19 formed of a cover layer 19a with a thickness t₃ and an information recording surface 19b. On the first optical disc 17, recording and reading of information are performed by the light beam of the wavelength λ₁. On the second optical disc 18, recording and reading of information are performed by the light beam of the wavelength λ₂. On the third optical disc 19, recording and reading of information are performed by the light beam of the wavelength λ₃. The light beams of the wavelengths are focused on their respective information recording surfaces to thereby perform recording and reading of information. Among the wavelength λ₁, the wavelength λ₂ and the wavelength λ₃, a relationship of λ₁<λ₂<λ₃ holds, and among the thicknesses t₁, t₂ and t₃ of the cover layers of the optical discs, a relationship of t₁<t₂<t₂ holds.

For example, the first optical disc 17 is a BD, and the wavelength λ₁ is a light beam of a 405-nm wavelength band (375 nm≦λ₁≦435 nm); the second optical disc 18 is a DVD, and the wavelength λ₂ is a light beam of a 660-nm wavelength band (630 nm≦λ₂≦690 nm); the third optical disc 19 is a CD, and the wavelength λ₃ is a light beam of a 780-nm wavelength band (750 nm≦λ₃≦810 nm).

While the first optical disc 17, the second optical disc 18 and the third optical disc 19 are shown in FIG. 2, the number of kinds of optical discs on which recording and reading can be performed at one time is one, and recording and reading of information are performed on one of the three kinds of the first optical disc 17, the second optical disc 18 and the third optical disc 19. That is, on the first optical disc 17, recording and reading of information are performed by the light beam 14 of the wavelength λ₁ being incident thereon, on the second optical disc 18, recording and reading of information are performed by the light beam 15 of the wavelength λ₂ being incident thereon, and on the third optical disc 19, recording and reading of information are performed by the light beam 16 of the wavelength λ₃ being incident thereon. When the values of the numerical apertures NA when the light beams 14, 15 and 16 are incident on the first optical disc 17, the second optical disc 18 and the third optical disc 19 are NA₁, NA₂ and NA₃, respectively, a relationship of NA₁>NA₂>NA₃ holds.

In explaining the present embodiment, FIG. 2 shows a structure in which the light beam 14 of the wavelength λ₁ incident on the first optical disc 17 and the light beam 16 of the wavelength λ₃ incident on the third optical disc 19 are incident on the composite optical element 10 with an infinite system where they become parallel beams and the light beam 15 of the wavelength λ₂ incident on the second optical disc 18 is incident on the composite optical element 10 with a finite system where it travels while diverging or converging; however, the present invention is not limited thereto. A structure may be adopted in which the light beam 16 of the wavelength λ₃ incident on the third optical disc 19 is incident on the composite optical element 10 with a finite system and the light beam 15 of the wavelength λ₂ incident on the second optical disc 18 is incident on the composite optical element 10 with an infinite system. Moreover, a structure may be adopted in which the light beam of the wavelength λ₂ incident on the second optical disc 18 and the light beam 16 of λ₃ incident on the third optical disc 19 are both incident on the composite optical element 10 with a finite system.

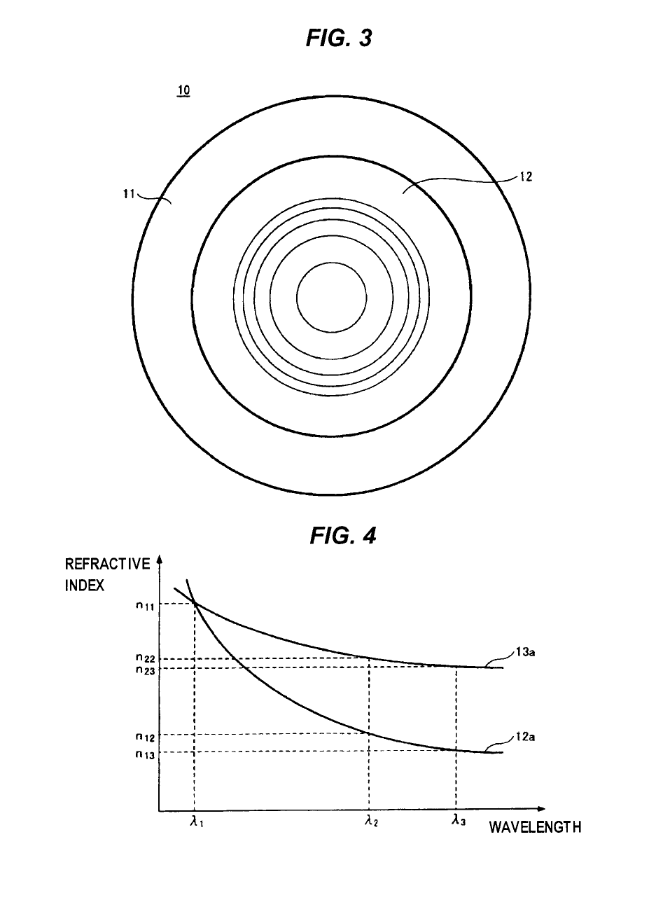

As described above, in the composite optical element 10 according to the present embodiment, the first resin layer 12 is formed on the surface of the single lens 11, the second resin layer 13 is formed on the surface of the first resin layer 12, and by the surface of junction (interface) between the first resin layer 12 and the second resin layer 13, a diffraction grating the cross-sectional configuration of which is a blaze configuration is formed in a region where the light beam 15 of the wavelength λ₂ and the light beam 16 of the wavelength λ₃ are transmitted. FIG. 3 is a view schematically showing the condition of the first resin layer 12 formed on the single lens 11 from the direction of the optical axis of the composite optical element 10 in the composite optical element 10 according to the present embodiment. For the single lens 11, glass, a resin material or the like is used. In the case of glass, a low-refractive-index glass is preferably used, and when plastic is used as the resin material, it can be formed into a lens shape such as an objective lens by press working by using cycloolefin polymer (COP) or the like.

The first resin layer 12 may have convex and concave such as a blaze configuration outside the light beam 15 (the peripheral side with respect to the optical axis). The convex and concave configuration in this case is such that even when the light beam of the wavelength λ₂ and the light beam of the wavelength λ₃ are incident, they are not focused on the second optical disc 18 and the third optical disc 19, respectively. When convex and concave are provided outside the light beam 15 like this, since the surface area where the first resin layer 12 and the second resin layer 13 are in contact with each other increases, the adhesiveness between these resins increases. Thereby, reliability increases, and when the second resin layer 13 is laminated on the first resin layer, the flow of the resin can be prevented by these convex and concave, so that a deformation due to resin contraction can be suppressed. This provision of convex and concave may be similarly used in the embodiments shown below.

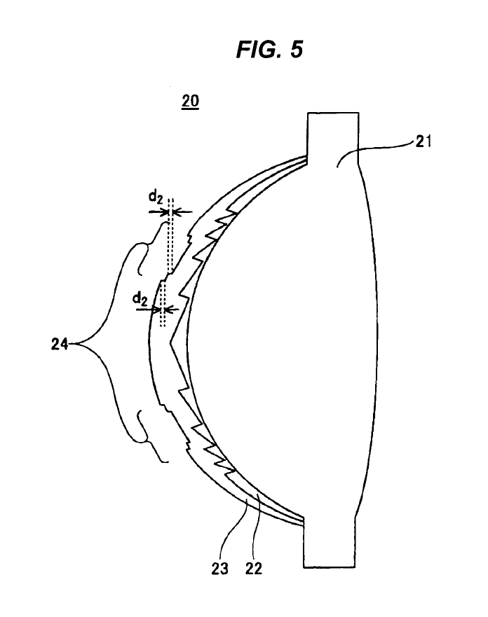

For the first resin layer 12 and the second resin layer 13, materials having characteristics of different refractive indices and Abbe numbers for the wavelength of the incident light beam are used, respectively. FIG. 4 shows a relationship between the wavelength and the refractive index (wavelength dispersion characteristic) at the first resin layer 12 and the second resin layer 13. For example, a refractive index characteristic 12a represents the wavelength dispersion characteristic at the first resin layer 12, and a refractive index characteristic 13a represents the wavelength dispersion characteristic at the second resin layer 13. The refractive index of the first resin layer 12 and the refractive index of the second resin layer 13 are substantially the same value at a refractive index n₁₁ in the band of the wavelength λ₁. However, in the band of the wavelength λ₂, the refractive index of the first resin layer 12 which is n₁₂ and the refractive index of the second resin layer 13 which is n₂₂ are different values. In the band of the wavelength λ₃, the refractive index of the first resin layer 12 which is n₁₃ and the refractive index of the second resin layer 13 which is n₂₃ are different values. Here, the band of the wavelength means a wavelength region of 0.97 λₓ to 1.03 λₓ for a specific wavelength λₓ. That the values of the refractive indices are substantially the same is that |Δn_{A}|≦0.02 where the difference between the refractive indices of two resin materials for a light beam of a specific wavelength is Δn_{A}, and this applied to the embodiments shown below.

While FIG. 4 shows a case where in the light beam of the wavelength λ₂ and the light beam of the wavelength λ₃, the refractive index of the second resin layer 13 is high compared with the refractive index of the first resin layer 12, similar effects can be obtained in a converse case where the refractive index of the first resin layer 12 is high compared with the refractive index of the second resin layer 13. Moreover, when FIG. 4 is referred to in the other embodiments shown below, the refractive index characteristic 12a also represents the wavelength dispersion characteristic at the first resin layer, and the refractive index characteristic 13a also represents the wavelength dispersion characteristic at the second resin layer.

Here, as the low-Abbe-number resin material, a resin material containing aromatic hydrocarbon or a resin containing low-Abbe-number inorganic microparticles of TiO₂, Nb₂O₅ or the like may be used. Aromatic hydrocarbon sometimes has absorption in the ultraviolet wavelength region, and a steep refractive index dispersion can be obtained in the vicinity of a wavelength of 405 nm. However, it tends to become deteriorated when a light beam of a wavelength of 405 nm is radiated, and to avoid this, it is preferable that it contain a structure such as a phenylsilane structure having deterioration resistance to the wavelength of 405 nm.

As the high-Abbe-number resin material, aliphatic hydrocarbon, fluoric hydrocarbon or sulfuric hydrocarbon may be used. Moreover, materials where high-Abbe-number inorganic microparticles of ZrO₂, SiO₂, Al₂O₃, La₂O₃ or the like are contained in these resins may be used. In aromatic hydrocarbon, although a gentle refractive index dispersion is obtained, since the refractive index tends to decrease, it is preferable to adjust the refractive index with the low-Abbe-number material by increasing the refractive index by incorporating a material of an adamantane structure, a diadamantane structure or the like.

Next, the concrete structure of the composite optical element 10 will be described. As shown in FIG. 2, the height h₁ of the blaze (the height of the blaze on the diffractive surface) of the first resin layer 12 provided substantially parallel to the direction of the light beam traveling through the first resin layer 12 is such that the value of Δn×h₁/λ where the difference in refractive index between two resins at the wavelength λ is Δn is substantially 1 in the wavelength band from the wavelength λ₂ to the wavelength λ₃. Here, being substantially 1 is, preferably, being in the range of 0.5≦Δn×h₁/λ≦1.5, and more preferably, being in the range of 0.7≦Δn×h₁/λ≦1.3.

The present invention is not limited to the case where the height of the blaze of the first resin layer 12 is the value of only h₁ over the entire surface, but the height may be uneven such as having a value of a height different from h₁. For example, when the diffraction efficiency of the light beam of the wavelength λ₂ and the diffraction efficiency of the light beam of the wavelength λ₃ are changed from a predetermined value, they may be freely set such as binarizing the height of the blaze of the first resin layer 12. When the distance between adjacent vertices of the first resin layer 12 having a Fresnel lens configuration (=Fresnel pitch) is short, there are cases where the diffraction efficiency changes with respect to a predetermined value. In this case, the diffraction efficiency can be uniformized by adjusting the height for each pitch, for example, by providing gradations of heights from the optical axis toward the periphery. When the height is made uneven over the entire surface, it is necessary only that the value of the height h be set so that 0.8×h₁≦h≦1.2×h₁ where a predetermined height is h₁. Providing the height with an uneven distribution like this may be similarly used in the embodiments shown below.

It is necessary only that the resin material that can be used for the first resin layer 12 and the second resin layer 13 be a material that satisfies the above-described refractive index relationship, and resin materials of a heat curable type and an ultraviolet curable type may be used. Moreover, a hybrid material in which inorganic microparticles are mixed may be used as long as it is a material containing resin. As the method of bonding the first resin layer 12 and the second resin layer 13 to the single lens 11 and forming a diffractive surface at the interface between the first resin layer 12 and the second resin layer 13, the imprinting method by ultraviolet rays or heat may be used.

In the thus formed composite optical element 10 according to the present embodiment, since the refractive index at the first resin layer 12 and the refractive index at the second resin layer 13 are substantially the same value for the light beam of the wavelength λ₁, the light beam of the wavelength λ₁ is not diffracted at the interface between the first resin layer 12 and the second resin layer 13 but advances. Therefore, when the light beam of the wavelength λ₁ is incident on the composite optical element 10 with an infinite system, the configurations of the single lens 11, the first resin layer 12 and the second resin layer 13 are determined so that the light beam can be focused on the information recording surface 17b of the first optical disc 17.

On the other hand, when the light beam of the wavelength λ₃ is incident with an infinite system, since it is diffracted by the diffraction grating formed at the interface between the first resin layer 12 and the second resin layer 13, the light beam of the wavelength λ₃ can be focused on the surface of the information recording surface 19b of the third optical disc 19 in a condition where the distance between the composite optical element 10 and the third optical disc 19 is sufficiently maintained, and spherical aberration caused by the difference in thickness between the cover layer 17a of the first optical disc 17 and the cover layer 19a of the third optical disc 19 can be corrected.

Further, in the composite optical element 10 according to the present embodiment, the light beam of the wavelength λ₂ can be focused on the information recording surface 18b of the second optical disc 18 by making the light beam of the wavelength λ₂ incident with a finite system and correcting the spherical aberration. That is, the light beam of the wavelength λ₂ can be focused on the information recording surface 18b of the second optical disc 18 by adjusting the divergence condition (divergence angle) of the light beam of the wavelength λ₂ incident on the composite optical element 10 and the performance (specification) of the diffraction grating that diffracts and focuses the incident light.

In the composite optical element 10 according to the present embodiment, by the above-described structure, the light beam of the wavelength λ₁, the light beam of the wavelength λ₂ and the light beam of the wavelength λ₃ can be focused in a condition where the distance between the composite optical element 10, and the first optical disc 17, the second optical disc 18 and the third optical disc 19 is sufficiently maintained.

### Second Embodiment

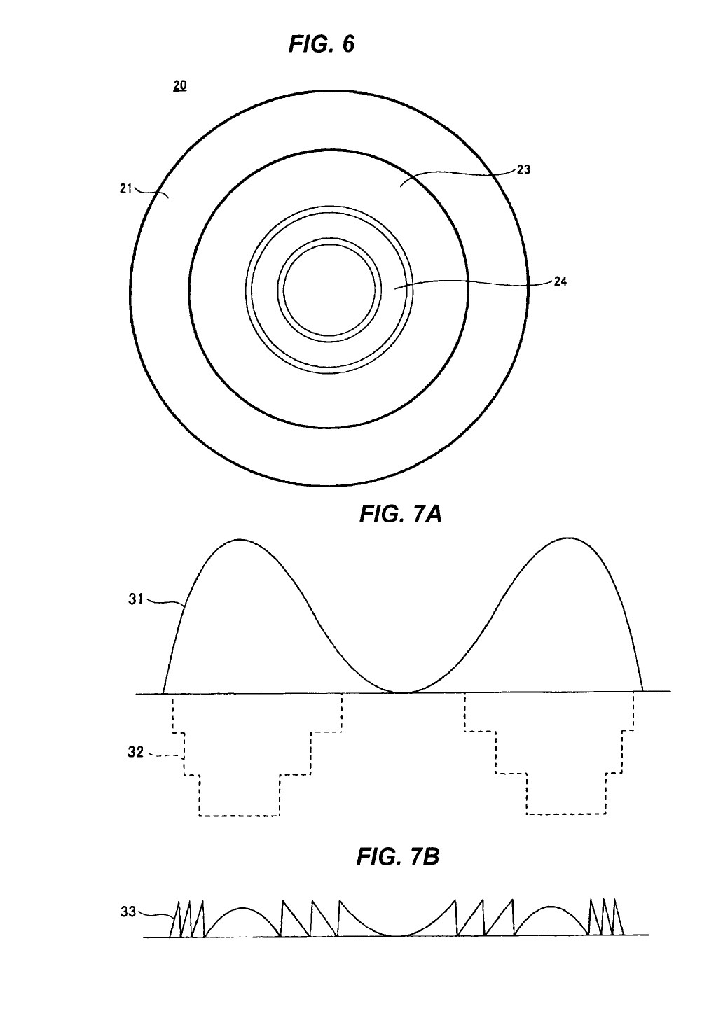

Next, a second embodiment will be described. Based on FIG. 5, a composite optical element according to the present embodiment will be described. The composite optical element according to the present embodiment has a structure including a single lens.

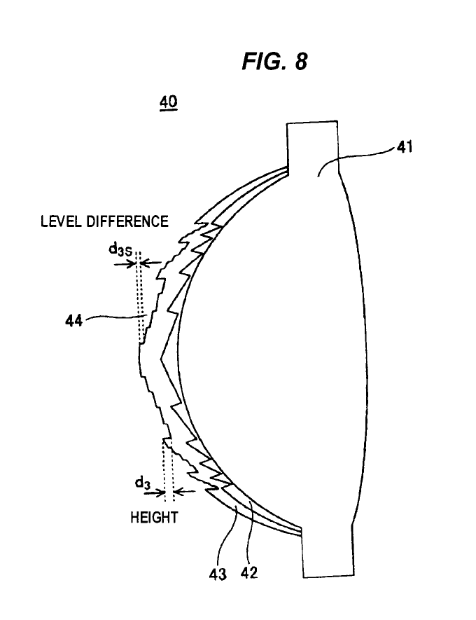

In the composite optical element 20 according to the present embodiment, a first resin layer 22 is formed on the surface of a single lens 21, a second resin layer 23 is formed on the surface of the first resin layer 22, and these are integrated with one another. By the interface between the first resin layer 22 and the second resin layer 23, a diffraction grating the cross-sectional configuration of which is a blaze configuration is formed, and on the surface of the second resin layer 23, that is, on the surface that is not in contact with the first resin layer 22, a phase level difference 24 is formed. The refractive index of the first resin layer 22 and the refractive index of the second resin layer 23 are substantially the same value in the band of the wavelength λ₁, are different values in the band of the wavelength λ₂ and in the band of the wavelength λ₃, and have a wavelength dispersion characteristic as shown in FIG. 4. The light beam of the wavelength λ₂ and the light beam of the wavelength λ₃ are incident on the composite optical element 20 with a finite system. FIG. 6 is a view schematically showing, from the direction of the optical axis, a condition where the phase level difference 24 on the surface of the second resin layer 23 is formed in the composite optical element 20 according to the present embodiment. In the present embodiment, on the surface of the second resin layer 23, a region where the phase level difference 24 is formed will be referred to as a peripheral region, and a region including the optical axis and where the phase level difference 24 is not formed will be referred to as a central region.

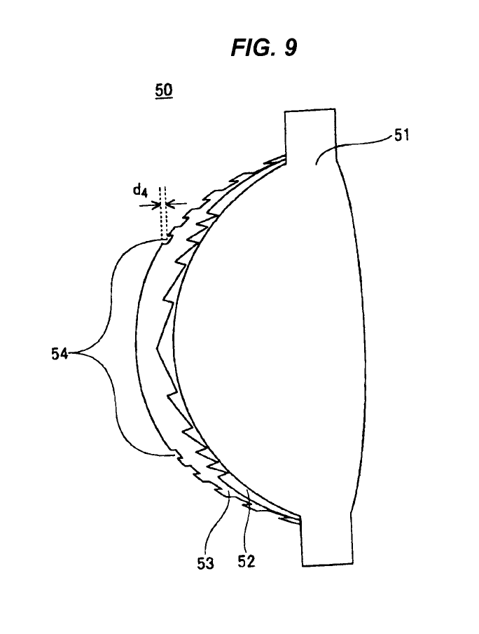

Next, based on FIGS. 7A and 7B, the phase level difference 24 of the composite optical element 20 according to the present embodiment and effects thereof will be described. The phase level difference 24 is formed to correct residual aberration in the composite optical element 20. For example, in a case where since the phase level difference 24 is not formed, the residual wavefront aberration has a distribution like a wavefront aberration 31 in FIG. 7A when the light beam of the wavelength λ₂ is incident and focused on the second optical disc, spherical aberration is reduced by performing a correction to provide, by the phase level difference 24, a phase difference as shown at a wavefront aberration 32 so as to cancel out the wavefront aberration 31. FIG. 7B is a view showing a residual wavefront aberration 33 which is the difference when the wavefront aberration 32 is subtracted from the wavefront aberration 31. FIGS. 7A and 7B are views showing the wavefront aberrations on the cross section along the optical axis of the composite optical element 20 according to the present embodiment, and the spherical aberration as the wavefront aberration 31 is caused so as to be distributed rotationally symmetrically with respect to the optical axis. The peripheral region is an annular region that is rotationally symmetrical with respect to the optical axis.

Since the size of the spherical aberration caused by the composite optical element 20 according to the present embodiment is different among the light beam of the wavelength λ₁, the light beam of the wavelength λ₂ and the light beam of the wavelength λ₃, it is preferable that the target be only the light beam of a specific wavelength for which spherical aberration correction by the phase level difference 24 is particularly intended and that no excess spherical aberration be caused for the light beams of the other wavelengths. For example, when it is intended to correct wavefront aberration only for the light beam of the wavelength λ₂, the composite optical element 20 is formed so that a level difference d₂ at the phase level difference 24 satisfies the following expressions of (1) to (3):

(m₁−0.1)λ₁≦d₂(n₂(λ₁)−1)≦(m₁+0.1)λ₁ (1)

(m₂+0.1)λ₂<d₂(n₂(λ₂)−1)<(m₂+0.9)λ₂ (2)

(m₃−0.1)λ₃≦d₂(n₂(λ₃)−1)≦(m₃+0.1)λ₃ (3)

Here, n₂(λ₁), n₂(λ₂) and n₃(λ₃) are the refractive index of the light beam of the wavelength λ₁, the refractive index of the light beam of the wavelength λ₂ and the refractive index of the light beam of the wavelength λ₃ at the second resin layer 23, respectively. Moreover, m₁, m₂ and m₃ are integers. The composite optical element 20 according to the present embodiment is formed so as to satisfy the above expressions shown at (1) to (3). The level difference d₂ corresponds to the height substantially parallel to the optical axis. While the phase level difference 24 the number of level differences d₂ of which is two (the number of steps=2) is shown as an example in FIG. 5, the number of steps may be three or more as long as the wavefront aberration 31 can be canceled out.

Thereby, in the composite optical element 20 according to the present embodiment, when the correction of the wavefront (spherical) aberration is insufficient, the wavefront (spherical) aberration at a predetermined wavelength can be corrected, and the light beam of the wavelength λ₁, the light beam of the wavelength λ₂ and the light beam of the wavelength λ₃ can be excellently focused on the first optical disc 17, the second optical disc 18 and the third optical disc 19 with a low wavefront (spherical) aberration amount. Moreover, while the phase level difference 24 is formed on the surface of the second resin layer 23 in the present embodiment, a configuration may be adopted in which a phase difference is added to the diffraction grating surface of the first resin layer 22. The contents other than the above-described ones are similar to those of the first embodiment.

### Third Embodiment

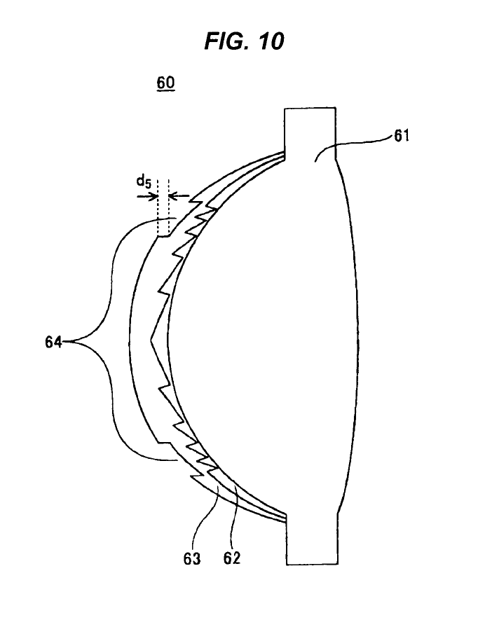

Next, a third embodiment will be described. FIG. 8 is a view schematically showing a composite optical element 40 according to the present embodiment. In the composite optical element 40 according to the present embodiment, a first resin layer 42 is formed on the surface of a single lens 41, a second resin layer 43 is formed on the surface of the first resin layer 42, and these are integrated with one another. By the interface between the first resin layer 42 and the second resin layer 43, a diffraction grating similar to that of the first embodiment the cross-sectional configuration of which is a blaze configuration is formed, and to distinguish this from another diffraction grating described later, this diffraction grating will be referred to as a first diffraction grating. A second diffraction grating 44 is formed on the surface of the second resin layer 43, that is, the surface of the second resin layer 43 that is not in contact with the first resin layer 43. The refractive index of the first resin layer 42 and the refractive index of the second resin layer 43 are substantially the same value in the band of the wavelength λ₁, are different values in the band of the wavelength λ₂ and in the band of the wavelength λ₃, and have a wavelength dispersion characteristic as shown in FIG. 4.

The second diffraction grating 44 is formed on the entire surface of the second resin layer 43, and by diffracting the incident light beam also at the second diffraction grating 44, the caused aberration can be reduced to improve light focusing performance. That is, this is for correcting residual aberration when residual aberration is left also at the first diffraction grating. The light beam incident on the surface of the resin layer 43 has its direction of travel changed since it is diffracted by the second diffraction grating 44, residual aberration is corrected by diffracting by the first diffraction grating the light beam of a wavelength that is different in refractive index between the first resin layer 42 and the second resin layer 43, and the light beams of the wavelengths are focused on the first optical disc 17, the second optical disc 18 and the third optical disc 19.

When the second diffraction grating 44 has a blaze configuration, the diffraction efficiency is maximum when the height d₃ of the blaze configuration substantially parallel to the optical axis satisfies the following expressions at (4) to (6):

(m₁−0.3)λ₁≦d₃(n₂(λ₁)−1)≦(m₁+0.3)λ₁ (4)

(m₂−0.3)λ₂≦d₃(n₂(λ₂)−1)≦(m₂+0.3)λ₂ (5)

(m₃−0.3)λ₃≦d₃(n₂(λ₃)−1)≦(m₃+0.3)λ₃ (6)

Here, n₂(λ₁), n₂(λ₂) and n₂(λ₃) are the refractive index of the light beam of the wavelength λ₁, the refractive index of the light beam of the wavelength λ₂ and the refractive index of the light beam of the wavelength λ₃ at the second resin layer 43, respectively. Moreover, m₁, m₂ and m₃ are integers. The composite optical element 40 according to the present embodiment is formed so as to satisfy the above expressions at (4) to (6).

Thereby, by using three optical characteristics of the light refraction at the composite optical element 40 according to the present embodiment, the light diffraction at the surface (second diffraction grating) of the second resin layer 43 and the light diffraction at the interface (first diffraction grating) between the first resin layer 42 and the second resin layer 43, a design with a high degree of freedom can be realized so that the light beams of the wavelengths are excellently focused on the information recording surfaces of the optical discs.

Here, since it is assumed that the refractive indices of the first resin layer 42 and the second resin layer 43 included in the composite optical element 40 according to the present embodiment have a wavelength dispersion characteristic as shown in FIG. 4, the light beam of the wavelength λ₁ is focused on the first optical disc 17 by the light refraction at the composite optical element 40 and the light diffraction at the second resin layer 43. The light beam of the wavelength λ₂ is focused on the second optical disc 18 by the light refraction at the composite optical element 40, the light diffraction at the second diffraction grating and the light diffraction at the first diffraction grating. The light beam of the wavelength λ₃ is focused on the third optical disc 19 by the light refraction at the composite optical element 40, the light diffraction at the second diffraction grating and the light diffraction at the first diffraction grating.

Moreover, when the cross sectional configuration of the second diffraction grating 44 is a pseudo blaze configuration where a blaze configuration is approximated in a step form as shown in FIG. 8, a different optical action can be provided to the light beams of the wavelengths. For example, when it is intended to diffract only the light beam of the wavelength λ₂ by the second diffraction grating 44, by forming the composite optical element 40 so that a level difference d_{3S} of each step of the pseudo blaze configuration satisfies the following expressions of (7) to (9), only the light beam of the wavelength λ₂ is acted upon, and the light beam of the wavelength and the light beam of the wavelength λ₃ are transmitted without diffracted by the second diffraction grating 44:

(p₁−0.1)λ₁≦d_{3S}(n₂(λ₁)−1)≦(p₁+0.1)λ₁ (7)

(p₂+0.1)λ₂<d_{3S}(n₂(λ₂)−1)<(p₂+0.9)λ₂ (8)

(p₃−0.1)λ₃≦d_{3S}(n₂(λ₃)−1)≦(p₃+0.1)λ₃ (9)

Moreover, p₁, p₂ and p₃ are integers. Thereby, when the cross-sectional configuration of the second diffraction grating 44 is the pseudo blaze configuration, by using three optical characteristics of the refraction at the composite optical element 40 according to the present embodiment, the selective diffraction of the wavelength of the incident light beam at the second diffraction grating and the diffraction at the first diffraction grating, a design with a high degree of freedom can be realized so that the light beams of the wavelengths are excellently focused on the information recording surfaces of the optical discs.

Here, since it is assumed that the refractive indices of the first resin layer 42 and the second resin layer 43 included in the composite optical element 40 according to the present embodiment have a wavelength dispersion characteristic as shown in FIG. 4, the light beam of the wavelength λ₁ is focused on the information recording surface 17b of the first optical disc 17 by the light refraction at the composite optical element 40. The light beam of the wavelength λ₂ is focused on the information recording surface 18b of the second optical disc 18 by the light refraction at the composite optical element 40, the light diffraction at the second diffraction grating and the light diffraction at the first diffraction grating. The light beam of the wavelength λ₃ is focused on the information recording surface 19b of the third optical disc 19 by the light refraction at the composite optical element 40 and the light diffraction at the first diffraction grating.

While it is preferable that the light beam of the wavelength λ₁ be incident on the composite optical element 40 with an infinite system in the present embodiment, the light beam of the wavelength λ₂ and the light beam of the wavelength λ₃ may be incident with either an infinite system or a finite system. In the composite optical element 40 according to the present invention, it is possible to focus the light beams of the wavelengths and sufficiently maintain the distance between the composite optical element 40, and the first optical disc 17, the second optical disc 18 and the third optical disc 19. The contents other than the above-described ones are similar to those of the first embodiment.

### Fourth Embodiment

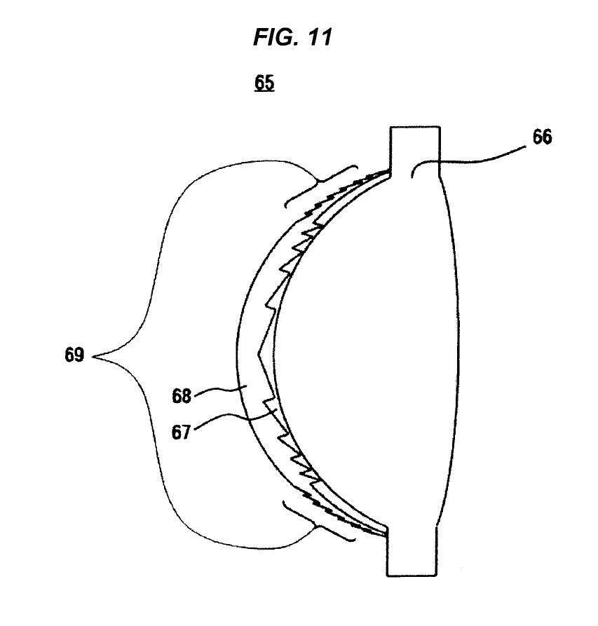

Next, a fourth embodiment will be described. FIG. 9 is a view schematically showing a composite optical element 50 according to the present embodiment. In the composite optical element 50 according to the present embodiment, a first resin layer 52 is formed on the surface of a single lens 51, a second resin layer 53 is formed on the surface of the first resin layer 52, and these are integrated with one another. By the interface between the first resin layer 52 and the second resin layer 53, a diffraction grating similar to that of the first embodiment the cross-sectional configuration of which is a blaze configuration is formed, and to distinguish this from another diffraction grating described later, this diffraction grating will be referred to as a first diffraction grating. On the surface of the second resin layer 53, that is, on the surface that is not in contact with the first resin layer 53, a second diffraction grating 54 of a binary type is formed. In the present embodiment, on the surface of the second resin layer 53, a region where the second diffraction grating 54 is formed will be referred to as a peripheral region, and a region including the optical axis and where the second diffraction grating 54 is not formed will be referred to as a central region. The refractive index of the first resin layer 52 and the refractive index of the second resin layer 53 are substantially the same value in the band of the wavelength λ₁, are different values in the band of the wavelength λ₂ and in the band of the wavelength λ₃, and have a wavelength dispersion characteristic as shown in FIG. 4.

In the present embodiment, it is preferable that the light beam of the wavelength λ₁ be incident on the composite optical element 50 according to the present embodiment with an infinite system, and the light beam of the wavelength λ₂ and the light beam of the wavelength λ₃ are incident on the composite optical element 50 according to the present embodiment with a finite system. A structure may be adopted in which either the light beam of the wavelength λ₂ or the light beam of the wavelength λ₃ is incident on the composite optical element 50 with an infinite system.

The second diffraction grating 54 is formed in the peripheral region of the second resin layer 53, and acts to limit the size of the aperture. The region where the second diffraction grating 54 is formed is an annular region that is rotationally symmetrical with respect to the optical axis, and when the light beam of the wavelength λ₃ is incident on the second diffraction grating 54, the second diffraction grating 54 diffracts the light beam to thereby limit the aperture of the light beam focused on the third optical disc 19 conforming to the light beam of the wavelength λ₃. On the other hand, the light beam of the wavelength λ₁ and the light beam of the wavelength λ₂ are focused on the first optical disc 17 and the cover layer 18b of the second optical disc 18, respectively, without diffracted at the second diffraction grating 54. That is, of the light beam of the wavelength λ₃, the light beam incident on the second diffraction grating 54 as the peripheral region and diffracted is not focused on the information recording surface 19b of the third optical disc 19 and only the light beam transmitted by the central region including the optical axis and where the second diffraction grating 54 is not formed is focused on the information recording surface 19b of the third optical disc 19.

While the first to third embodiments have been described on the assumption that the light beams of the wavelengths are incident on the composite optical element under a condition where the aperture is limited and the NA is a desired one, in the present embodiment, by thus forming the second diffraction grating 54 that develops the function of wavelength-selectively limiting the aperture of the incident light beam, it is sometimes unnecessary to use an optical element or the like that develops the aperture limitation function separately from the composite optical element 50 in an optical system using the composite optical element 50.

To develop such an aperture limitation function, in the composite optical element 50 according to the present embodiment, the height d₄, substantially parallel to the optical axis, of the second diffraction grating 54 is formed so as to satisfy the following expressions at (10) to (12):

(m₁−0.2)λ₁≦d₄(n₂(λ₁)−1)≦(m₁+0.2)λ₁ (10)

(m₂−0.2)λ₂≦d₄(n₂(λ₂)−1)≦(m₂+0.2)λ₂ (11)

(m₃−0.3)λ₃≦d₄(n₂(λ₃)−1)≦(m₃+0.7)λ₃ (12)

Here, n₂(λ₁), n₂(λ₂) and n₂(λ₃) are the refractive index of the light beam of the wavelength λ₁, the refractive index of the light beam of the wavelength λ₂ and the refractive index of the light beam of the wavelength λ₃ at the second resin layer 53, respectively. Moreover, m₁, m₂ and m₃ are integers. When this is done, by satisfying the above (10) and (11), the light beam of the wavelength λ₁ and the light beam of the wavelength λ₂ incident with a numerical aperture larger than the numerical aperture (NA₃) of the light beam of the wavelength λ₃ are transmitted without diffracted at the second diffraction grating 54, and further, by satisfying the above (12), the plus/minus 1st order diffraction efficiency of the light beam of the wavelength λ₃ incident on the diffraction grating 54 becomes maximum and the quantity of the straight transmitted light beam becomes substantially 0 (the zero-order diffraction efficiency is substantially 0%), so that most of the light beam incident on the second diffraction grating 54 is not focused on the information recording surface 19b of the third optical disc 19 and the aperture limitation function improves, which is desirable.

Thereby, in the present embodiment, a light beam of the aperture size suitable for the light beam of each of the wavelengths can be focused on the optical disc, and the distance between the composite optical element 50, and the first optical disc 17, the second optical disc 18 and the third optical disc 19 can be sufficiently maintained. The contents other than the above-described ones are similar to those of the first embodiment.

### Fifth Embodiment

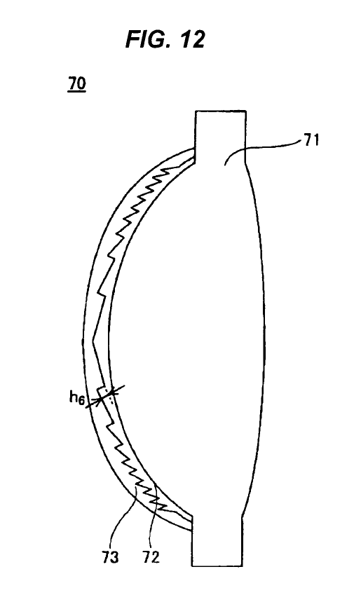

Next, a fifth embodiment will be described. FIG. 10 is a view schematically showing a composite optical element 60 according to the present embodiment. In the composite optical element 60 according to the present embodiment, a first resin layer 62 is formed on the surface of a single lens 61, a second resin layer 63 is formed on the surface of the first resin layer 62, and these are integrated with one another. By the interface between the first resin layer 62 and the second resin layer 63, a diffraction grating similar to that of the first embodiment the cross-sectional configuration of which is a blaze configuration is formed, and on the surface of the second resin layer 63, that is, on the surface that is not in contact with the second resin layer 63, a phase level difference 64 is formed. In the present embodiment, on the surface of the second resin layer 63, a region where the phase level difference 64 is formed will be referred to as a peripheral region, and a region including the optical axis and where the phase level difference 64 is not formed will be referred to as a central region. The refractive index of the first resin layer 62 and the refractive index of the second resin layer 63 are substantially the same value in the band of the wavelength λ₁, are different values in the band of the wavelength λ₂ and in the band of the wavelength λ₃, and have a wavelength dispersion characteristic as shown in FIG. 4.

In the present embodiment, it is preferable that the light beam of the wavelength λ₁ be incident on the composite optical element 60 according to the present embodiment with an infinite system, and the light beam of the wavelength λ₂ and the light beam of the wavelength λ₃ are incident on the composite optical element 60 according to the present embodiment with a finite system. A structure may be adopted in which either the light beam of the wavelength λ₂ or the light beam of the wavelength λ₃ is incident on the composite optical element 60 with an infinite system.

The phase level difference 64 is formed in the peripheral region of the second resin layer 63, and acts to limit the size of the aperture of the light beam of the wavelength λ₃. The region where the phase level difference 64 is formed is an annular region that is rotationally symmetrical with respect to the optical axis, and acts to provide a phase difference between, of the light beam of the wavelength λ₃ incident on the second region layer 63, the annular peripheral region where the phase level difference 64 is formed and the central region including the optical axis and where the phase level difference 64 is not formed. Specifically, a large aberration is caused by changing the phase of only the light beam of the wavelength λ₃ by the phase level difference 64. By the caused aberration, the light beam transmitted by the phase level difference 64 is not focused on the information recording surface 19b of the third optical disc 19, and only the light beam transmitted by the central region where the phase level difference 64 is not formed is focused on the information recording surface 19b of the third optical disc 19. Consequently, there are cases where in an optical system using the composite optical element 60, it is unnecessary to use an optical element or the like having the aperture limitation function separately from the composite optical element 60.

Thereby, the light beam of the wavelength λ₁ and the light beam of the wavelength λ₂ are focused on the information recording surfaces of the first optical disc 17 and the second optical disc 18 without the aberration at the phase level difference 64 being caused, and for the light beam of the wavelength λ₃, since a large aberration is caused for the light beam incident on the phase level difference 64, only the light beam incident on the central region inside the phase level difference 64 is focused on the information recording surface of the third optical disc 19.

To develop such an aperture limitation function, in the composite optical element 60 according to the present embodiment, the height d₅, substantially parallel to the optical axis, of the phase level difference 64 is formed so as to satisfy the following expressions at (13) to (15):

(m₁−0.2)λ₁≦d₅(n₂(λ₁)−1)≦(m₁+0.2)λ₁ (13)

(m₂−0.2)λ₂≦d₅(n₂(λ₂)−1)≦(m₂+0.2)λ₂ (14)

(m₃+0.3)λ₃≦d₅(n₂(λ₃)−1)≦(m₃+0.7)λ₃ (15)

Here, n₂(λ₁), n₂(λ₂) and n₃(λ₃) are the refractive index of the light beam of the wavelength λ₁, the refractive index of the light beam of the wavelength λ₂ and the refractive index of the light beam of the wavelength λ₃ at the second resin layer 63, respectively. Moreover, m₁, m₂ and m₃ are integers. By thus satisfying the above (13) and (14), a phase difference that is an integral multiple of these wavelengths is provided at the phase level difference 64, so that apparently, the light beam of the wavelength λ₁ and the light beam of the wavelength λ₂ that are incident are transmitted under the same condition as that when no phase difference is caused. Further, since the light beam of the wavelength λ₃ incident on the phase level difference 64 causes the largest phase difference for the central region by satisfying the above (15), the light focusing performance on the information recording surface of the third optical disc 19 for the light beam having transmitted by the phase level difference 64 is significantly reduced, so that the aperture limitation function improves, which is desirable.

Thereby, in the present embodiment, a light beam of the aperture size suitable for the light beam of each of the wavelengths can be focused on the optical disc, and the distance between the composite optical element 60, and the first optical disc 17, the second optical disc 18 and the third optical disc 19 can be sufficiently maintained. Moreover, while the phase level difference 64 is formed on the surface of the second resin layer 63 in the present embodiment, a configuration may be adopted in which a phase difference is added to the diffraction grating surface of the first resin layer 62. The contents other than the above-described ones are similar to those of the first embodiment.

### Sixth Embodiment

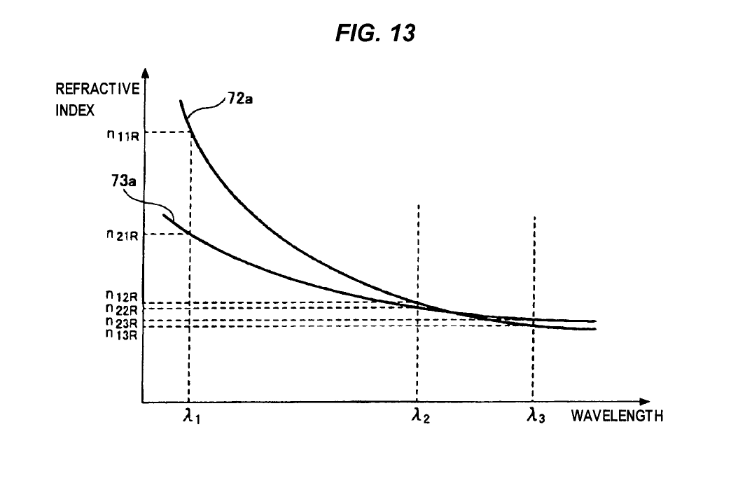

Next, a sixth embodiment will be described. FIG. 11 is a view schematically showing a composite optical element 65 according to the present embodiment. In the composite optical element 65 according to the present embodiment, a first resin layer 67 is formed on the surface of a single lens 66, a second resin layer 68 is formed on the surface of the first resin layer 67, and these are integrated with one another. By the interface between the first resin layer 67 and the second resin layer 68, a diffraction grating similar to that of the first embodiment the cross-sectional configuration of which is a blaze configuration is formed, and to distinguish this from another diffraction grating described later, this diffraction grating will be referred to as a first diffraction grating. On the surface of the second resin layer 68, that is, on the surface that is not in contact with the first resin layer 67, a second diffraction grating 69 of a blaze configuration is formed. In the present embodiment, on the surface of the second resin layer 68, a region where the second diffraction grating 69 is formed will be referred to as a peripheral region, and a region including the optical axis and where the second diffraction grating 69 is not formed will be referred to as a central region. The refractive index of the first resin layer 67 and the refractive index of the second resin layer 68 are substantially the same value in the band of the wavelength λ₁, are different values in the band of the wavelength λ₂ and in the band of the wavelength λ₃, and have a wavelength dispersion characteristic as shown in FIG. 4.

In the present embodiment, it is preferable that the light beam of the wavelength λ₁ be incident on the composite optical element 65 according to the present embodiment with an infinite system, and the light beam of the wavelength λ₂ and the light beam of the wavelength λ₃ are incident on the composite optical element 65 according to the present embodiment with a finite system. A structure may be adopted in which either the light beam of the wavelength λ₂ or the light beam of the wavelength λ₃ is incident on the composite optical element 65 with an infinite system.

The second diffraction grating 69 is formed in the peripheral region of the second resin layer 68, and this peripheral region is an annular region that is rotationally symmetrical with respect to the optical axis. Moreover, while the peripheral region where the second diffraction grating 69 is formed can be set as an arbitrary region, in this description, it corresponds to a region where only the light beam of the wavelength λ₁ the numerical aperture of which is large compared with the light beams of the other wavelengths is incident, and it is considered that the light beam of the wavelength λ₂ and the light beam of the wavelength λ₃ are not incident on the peripheral region. When the light beam of the wavelength λ₁ is incident on the central region and the peripheral region, by diffracting the light beam incident on the central region and while diffracting the light beam incident on the peripheral region by the second diffraction grating 69, the light beam of the wavelength λ₁ is focused on the first optical disc 17 conforming thereto. Moreover, the light beam of the wavelength λ₂ and the light beam of the wavelength λ₃ are focused on the second optical disc 18 and the third optical disc 19, respectively, as in the first embodiment.

In the composite optical element 65 according to the present embodiment, by providing the second diffraction grating of the blaze configuration particularly in the peripheral region, of the light beam of the wavelength λ₁ with a large numerical aperture, the light beam incident on the peripheral region can be diffracted at a predetermined diffraction angle. By making the diffraction angle of the peripheral region large, the configuration of the peripheral region of the composite optical element 65, particularly, of the single lens 66 can be made gentle. In this case, the processing accuracy of the composite optical element improves, and desired optical characteristics are easy to obtain. Moreover, chromatic aberration may be corrected by using the fact that the direction of chromatic dispersion is different between refraction and diffraction.

### Seventh Embodiment

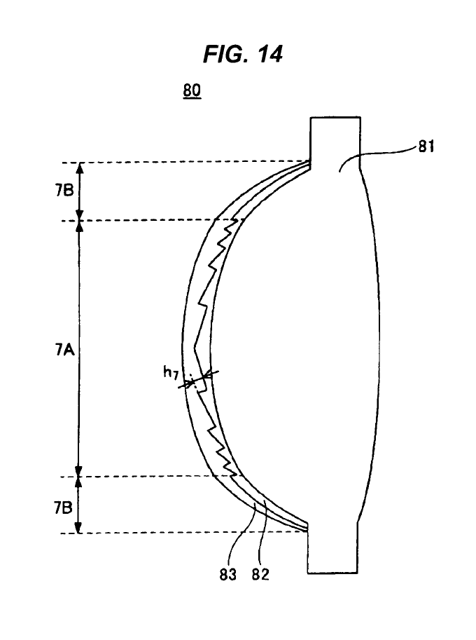

Next, a seventh embodiment will be described. FIG. 12 is a view schematically showing a composite optical element 70 according to the present embodiment. In the composite optical element 70 according to the present embodiment, a first resin layer 72 is formed on the surface of a single lens 71, a second resin layer 73 is formed on the surface of the first resin layer 72, and these are integrated with one another. By the interface between the first resin layer 72 and the second resin layer 73, a diffraction grating the cross-sectional configuration of which is a blaze configuration is formed.

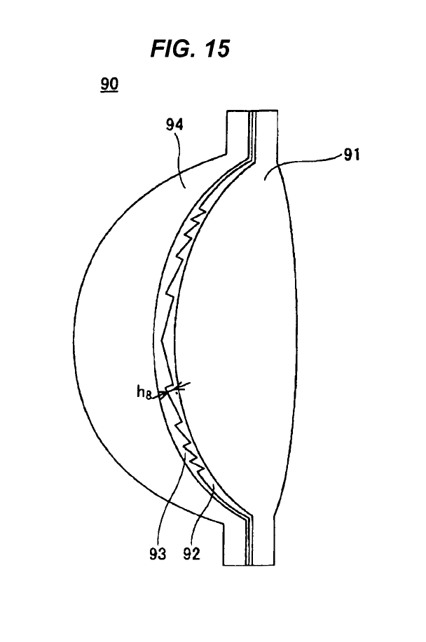

FIG. 13 shows a relationship between the wavelength and the refractive index (wavelength dispersion characteristic) at the first resin layer 72 and the second resin layer 73. A refractive index characteristic 72a represents the wavelength dispersion characteristic at the first resin layer 72, and a refractive index characteristic 73a represents the wavelength dispersion characteristic at the second resin layer 73. As shown in FIG. 13, in the band of the wavelength λ₁, the refractive index at the first resin layer 72 which is n_{11R} and the refractive index at the second resin layer 73 which is n_{21R} are different from each other. However, in the band of the wavelength λ₂, the refractive index at the first resin layer 72 which is n_{12R} and the refractive index at the second resin layer 73 which is n_{22R} are substantially the same value. Moreover, in the band of the wavelength λ₃, the refractive index at the first resin layer 72 which is n_{13R} and the refractive index at the second resin layer 73 which is n_{23R} are substantially the same value. It is preferable that the height h₆ of a blaze configuration provided in a direction substantially parallel to the direction of the light beam traveling through the first resin layer 72 which blaze configuration is formed by the interface between the first resin layer 72 and the second resin layer 73 satisfy an expression at (16) where the difference between the refractive index of the first resin layer 72 and the refractive index of the second resin layer 73, the refractive index difference, is Δn(λ₁):

(m₁−0.5)λ₁≦h₆Δn(λ₁)≦(m₁+0.5)λ₁ (16)

It is more preferable that it satisfy an expression at (17):

(m₁−0.3)λ₁≦h₆Δn(λ₁)≦(m₁+0.3)λ₁ (17)

Here, m₁ is a natural number. Thereby, in the diffraction grating formed by the interface between the first resin layer 72 and the second resin layer 73, when the light beam of the wavelength λ₁ is incident, it is diffracted, and when the light beam of the wavelength λ₂ and the light beam of the wavelength λ₃ are incident, they are transmitted substantially without diffracted. Moreover, the height of the blaze of the first resin layer 72 is not limited to the value of only h₆ over the entire surface, but may be uneven such as having a value of a height different from h₆.

The composite optical element 70 according to the present embodiment is formed in a configuration such that when the light beam of the wavelength λ₃ is incident, it is focused on the surface of the information recording surface 19b of the third optical disc 19 under a condition where the distance between the composite optical element 70 and the third optical disc is sufficiently maintained. Moreover, the composite optical element 70 is formed so that when the light beam of the wavelength λ₂ is incident, even if the thickness of the cover layer 18a of the second optical disc 18 and the thickness of the cover layer 19a of the third optical disc 19 are different, the spherical aberration caused thereby can be corrected. Moreover, when incident with an infinite system, the light beam of the wavelength λ₁ is focused on the information recording surface 17b of the first optical disc 17 by the light refraction at the composite optical element 70 and the light diffraction by the diffraction grating formed between the first resin layer 72 and the second resin layer 73. On the surface of the second resin layer 73, a phase level difference as shown in the second and fifth embodiments or a (second) diffraction grating as shown in the third and fourth embodiments may be provided.

Thereby, according to the present embodiment, the light beams can be focused under a condition where the distance between the composite optical element 70, and the first optical disc 17, the second optical disc 18 and the third optical disc 19 is sufficiently maintained. The contents other than the above-described ones are similar to those of the first embodiment. Moreover, when FIG. 13 is referred to in the other embodiments shown below, the refractive index characteristic 72a also represents the wavelength dispersion characteristic at the first resin layer, and the refractive index characteristic 73a also represents the wavelength dispersion characteristic at the second resin layer.

### Eighth Embodiment

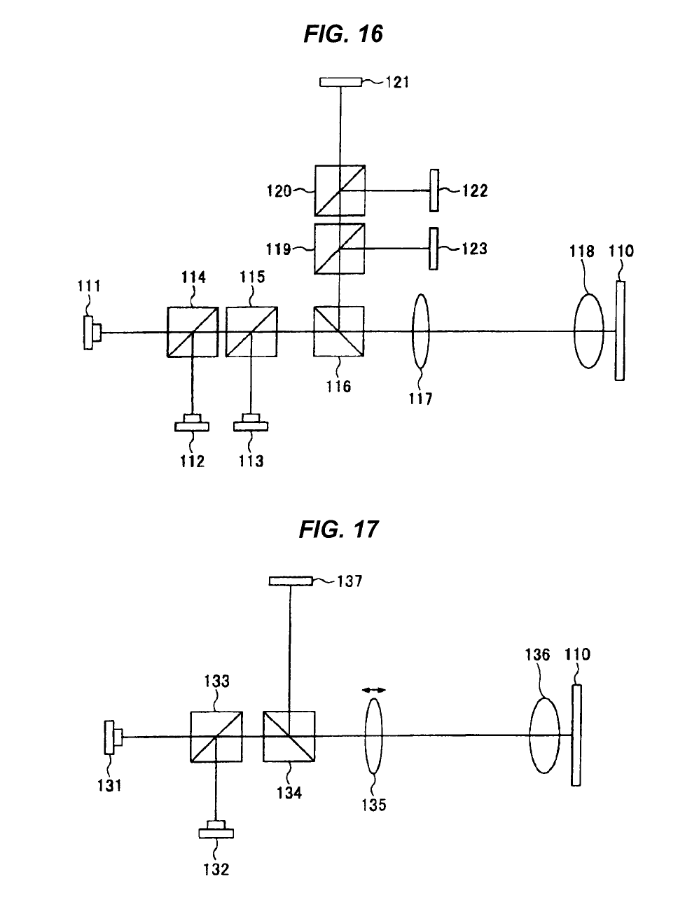

Next, an eighth embodiment will be described. FIG. 14 is a view schematically showing a composite optical element 80 according to the present embodiment. In the composite optical element 80 according to the present embodiment, a first resin layer 82 is formed on the surface of a single lens 81, a second resin layer 83 is formed on the surface of the first resin layer 82, and these are integrated with one another. By the interface between the first resin layer 82 and the second resin layer 83, a diffraction grating the cross-sectional configuration of which is a blaze configuration is formed in a partial region including the optical axis.

The composite optical element 80 according to the present embodiment has, specifically, a first region 7A in which the diffraction grating the cross-sectional configuration of which is a blaze configuration is formed by the interface between the first resin layer 82 and the second resin layer 83 and a second region 7B in which such a diffraction grating of a blaze configuration is not formed by the interface between the first resin layer 82 and the second resin layer 83. The first region 7A is a circular region including the optical axis, and the second region 7B is an annular region which is the peripheral part of the first region 7A. The first region 7A will be referred to also as an inner central region, and the second region 7B, also as an inner peripheral region.

Here, for example, when a diffraction grating is formed in the peripheral region as the second region 7B, since the pitch of the diffraction grating decreases in inverse proportion to the distance from the optical axis, a more precise manufacturing technology is required. The composite optical element 80 has a curved surface shape for focusing the light beam of the wavelength λ₁ incident on the second region 7B away from the optical axis, on the information recording surface 17b of the first optical disc 17 not by diffraction but only by refraction. That is, it is possible to focus the light beam of the wavelength λ₁ incident on the first region 7A, on the information recording surface 17b of the first optical disc 17 by light refraction and light diffraction and focus the light beam of the wavelength λ₁ incident on the second region 7B, on the information recording surface 17b of the first optical disc 17 by light refraction. The composite optical element 80 is formed so that the light beam of the wavelength λ₂ incident on the second region 7A is focused on the information recording surface 18b of the second optical disc 18 and that the light beam of the wavelength λ₃ is focused on the information recording surface 19b of the third optical disc 19.

The first resin layer 82 and the second resin layer 83 have the wavelength dispersion characteristic shown in FIG. 13 as in the case of the seventh embodiment. While in the band of the wavelength λ₁, the refractive index at the first resin layer 82 and the refractive index at the second resin layer 83 are different values, in the band of the wavelength λ₂, the refractive index at the first resin layer 82 and the refractive index at the second resin layer 83 are substantially the same value, and in the band of the wavelength λ₃, the refractive index at the first resin layer 82 and the refractive index at the second resin layer 83 are substantially the same value. It is preferable that the height h₇ of a blaze configuration provided in a direction substantially parallel to the direction of travel of the light beam incident on the first resin layer 82 which blaze configuration is formed between the first resin layer 82 and the second resin layer 83 satisfy an expression at (18) where the refractive index difference between the refractive index of the first resin layer 82 and the second resin layer 83 is Δn(λ₁):

(m₁−0.5)λ₁≦h₇Δn(λ₁)≦(m₁+0.5)λ₁ (18)

It is more preferable that it satisfy an expression at (19):

(m₁−0.3)λ₁≦h₇Δn(λ₁)≦(m₁+0.3)λ₁ (19)

Here, m₁ is a natural number. The composite optical element 80 according to the present embodiment is formed in a configuration such that in the first region 7A, when the light beam of the wavelength λ₃ is incident, it is focused on the information recording surface 19b of the third optical disc 19 under a condition where the distance between the composite optical element 80 and the third optical disc 19 is sufficiently maintained and in the second region 7B, when the light beam of the wavelength λ₁ is incident, it is focused on the information recording surface 17b of the first optical disc 17. Moreover, the height of the blaze of the first resin layer 82 is not limited to the value of only h₇ over the entire surface, but may be uneven such as having a value of a height different from h₇.

As described above, in the composite optical element 80 according to the present embodiment, when the light beam of the wavelength λ₁ is incident with an infinite system, the light beam transmitted by the first region 7A is diffracted by the diffraction grating formed by the interface between the first resin layer 82 and the second resin layer 83, and is focused on the information recording surface 17b of the first optical disc 17. In the second region 7B, the light beam is refracted and is focused on the information recording surface 17b of the first optical disc 17. The light beam of the wavelength λ₂ and the light beam of the wavelength λ₃ are incident on the first region 7A of the composite optical element 80 according to the present embodiment with a finite system or an infinite system, and are focused without diffracted by the diffraction grating formed by the interface between the first resin layer 82 and the second resin layer 83. On the surface of the second resin layer 83, a phase level difference as shown in the second and fifth embodiments or a (second) diffraction grating as shown in the third, fourth and sixth embodiments may be provided.

Thereby, according to the present embodiment, the light beams can be focused under a condition where the distance between the composite optical element 80, and the first optical disc 17, the second optical disc 18 and the third optical disc 19 is sufficiently maintained. The contents other than the above-described ones are similar to those of the seventh embodiment.

### Ninth Embodiment

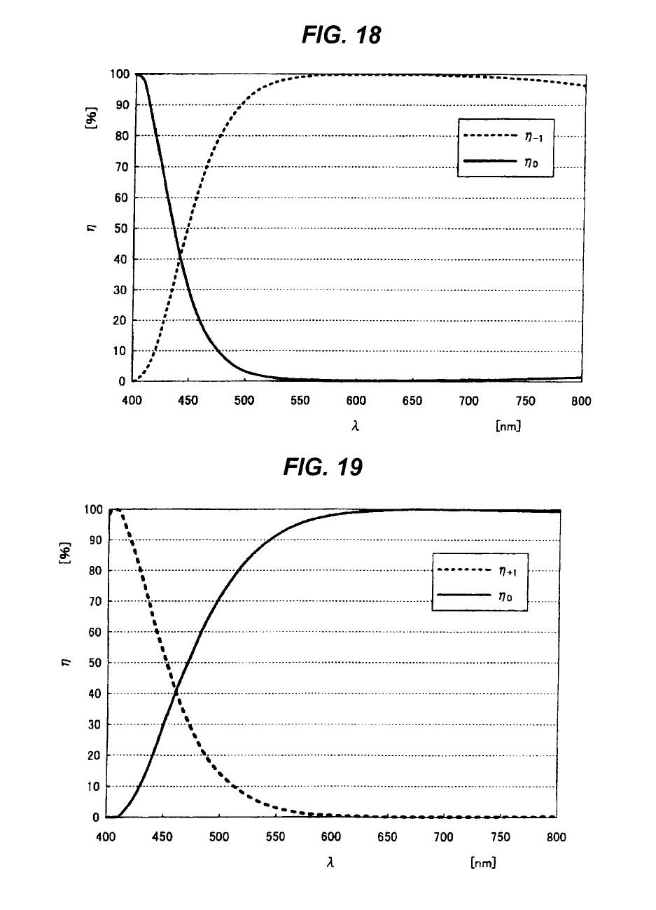

Next, a ninth embodiment will be described. FIG. 15 is a view schematically showing a composite optical element 90 according to the present embodiment. In the composite optical element 90 according to the present embodiment, a first resin layer 92 is formed on the surface of a single lens 91, a second resin layer 93 is formed on the surface of the first resin layer 92, and these are integrated with one another. By the interface between the first resin layer 92 and the second resin layer 93, a diffraction grating is formed where the cross-sectional configuration is ablaze configuration and the height provided in a direction substantially parallel to the direction of the light beam advancing through the first resin layer 92 is h₈. Further, a protective layer 94 is formed on the surface of the second resin layer 93.

Moreover, like the wavelength dispersion characteristic shown in FIG. 4, the refractive index of the first resin layer 92 and the refractive index of the second resin layer 93 are substantially the same value for the light beam in the band of the wavelength λ₁ and are different values for the light beam in the band of the wavelength λ₂ and the light beam in the band of the wavelength λ₃, or like the wavelength dispersion characteristic shown in FIG. 13, they are substantially the same value for the light beam in the band of the wavelength λ₂ and the light beam in the band of the wavelength λ₃ and are different values for the light beam in the band of the wavelength λ₁.

The single lens 91 may be formed into an aspherical surface shape by press working, or its both surfaces may be formed into a spherical surface shape by polishing. The material of the protective layer 94 may be the same as that of the single lens 91 or may be different therefrom. To form the protective layer 94, resin may be shaped directly on the second resin layer 93 or a lens-form member separately formed by pressing glass or resin may be bonded through the second resin layer 93.

A case will be described in which in the composite optical element 90 according to the present embodiment, like the wavelength dispersion characteristic shown in FIG. 4, the refractive index of the first resin layer 92 and the refractive index of the second resin layer 93 are substantially the same value for the light beam in the band of the wavelength λ₁ and are different values for the light beam in the band of the wavelength λ₂ and the light beam in the band of the wavelength λ₃. When the light beam of the wavelength λ₁ is incident with an infinite system, it is focused on the information recording surface 17b of the first optical disc 17 by the light refraction at the composite optical element 90. When the light beam of the wavelength λ₃ is incident, by the light refraction at the composite optical element 90 and the light diffraction by the diffraction grating formed by the interface between the first resin layer 92 and the second resin layer 93, the light beam of the wavelength λ₃ is focused on the information recording surface 19b of the third optical disc 19 under a condition where the distance between the composite optical element 90 and the third optical disc 19 is sufficiently maintained. When the light beam of the wavelength λ₂ is incident, by it being incident at a divergence angle different from the light beam of the wavelength λ₃, the spherical aberration caused by the cover layer 18a of the second optical disc 18 having a thickness different from the cover layer 19a of the third optical disc 19 is corrected, so that the light beam of the wavelength λ₂ can be focused on the information recording surface 18b of the second optical disc 18.

In the present embodiment, since the first resin layer 92 and the second resin layer 93 are protected by forming the protective layer 94, reliability can be improved, and the light beams can be focused under a condition where the distance between the composite optical element 80, and the first optical disc 17, the second optical disc 18 and the third optical disc 19 is sufficiently maintained. Moreover, the height of the blaze of the first resin layer 92 is not limited to the value of only h₈ over the entire surface, but may be uneven such as having a value of a height different from h₈.

On the surface of the second resin layer 93, a phase level difference as shown in the second and fifth embodiments or a (second) diffraction grating as shown in the third, fourth and sixth embodiments may be provided. Further, a structure may be adopted in which a diffraction grating is formed only one of the two regions as described in the eighth embodiment. The contents other than the above-described ones are similar to those of the first embodiment.

### Tenth Embodiment

Next, a tenth embodiment will be described. The present embodiment is an optical head device having the composite optical element in the first to ninth embodiments.

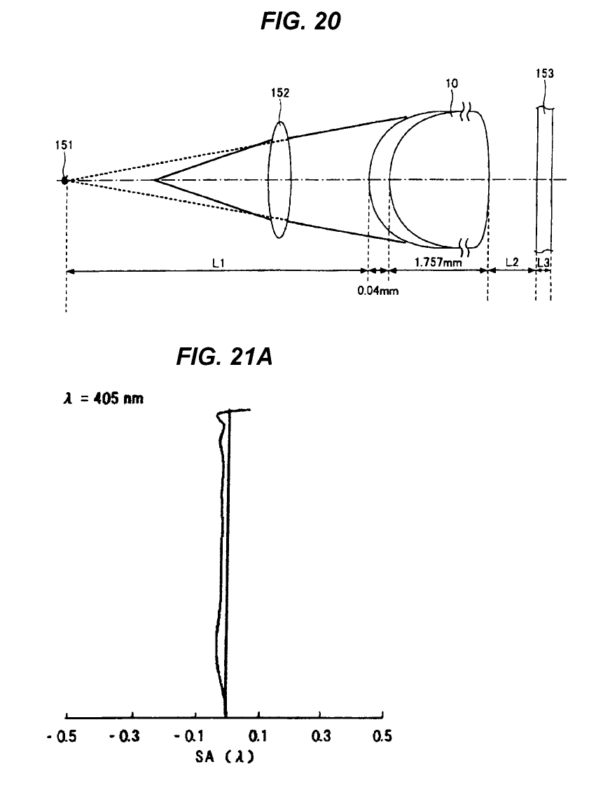

Based on FIG. 16, the optical head device according to the present embodiment will be described. The optical head device according to the present embodiment is an optical head device for performing recording and reading onto and from an optical disc 110, and is equipped for light beams of three different kinds of wavelengths. Specifically, it is equipped for, as the optical disc 110, three kinds of optical discs, the BD, the DVD and the CD which conform to the light beams of a 405-nm wavelength band, a 660-nm wavelength band and a 780-nm wavelength band, respectively.

The optical head device according to the present embodiment has: a first laser light source 111 that emits the light beam of the wavelength λ₁ which is the 405-nm wavelength band; a second laser light source 112 that emits the light beam of the wavelength λ₂ which is the 660-nm wavelength band; a third laser light source 113 that emits the light beam of the wavelength λ₃ which is the 780-nm wavelength band; a first beam splitter 114; a second beam splitter 115; a third beam splitter 116; a collimator lens 117; a composite optical element 118; a fourth beam splitter 119; a fifth beam splitter 120; a first photodetector 121; a second photodetector 122; and a third photodetector 123. As these beam splitters, polarization beam splitters, dichroic beam splitters or the like are used.

As the composite optical element 118, the composite optical element described in any of the first to ninth embodiments that develops an objective lens function may be used. As the collimator lens 117, a lens may be provided that is capable of adjusting the divergence angle of the light beam of each of the wavelengths incident on the composite optical element 118 by moving parallel to the optical axis. For the movement of the collimator lens 117, a non-illustrated stepping motor or the like is used. Specifically, when the distance between the position from each of the light sources and the object side principal point to the collimator lens 117 is s₁, the distance between the image side principal point of the collimator lens 117 and the position of image formation by the collimator lens 117 is s₂ and the focal length of the collimator lens 117 is f, an expression shown at Expression 1 holds. In the expression at Expression 1, since the divergence angle of the light beam incident on the collimator lens 117 is determined by the value of s₂, the value of s₁ and the value of f can be determined so that the divergence angle is a desired one.

$$\frac{1}{{s}_{2}} = \frac{1}{{s}_{1}} + \frac{1}{f} \qquad [ Expression 1 ]$$

In the present embodiment, the light beam of the wavelength λ₁ emitted from the first laser light source 111 straight travels through the first beam splitter 114, the second beam splitter 115 and the third beam splitter 116, is focused by the composite optical element 118 as an objective lens through the collimator lens 117, and is radiated to the optical disc 110. In this case, the optical disc 110 being read is a BD as the first optical disc conforming to the light beam of the wavelength λ₁. Thereafter, the light beam reflected at the information recording surface of the optical disc 110 is transmitted by the composite optical element 118 and the collimator lens 117, is deflected by the third beam splitter 116, straight travels through the fourth beam splitter 119 and the fifth beam splitter 120, and is incident on the first photodetector 121 where the signals recorded on the information recording surface of the optical disc 110 are converted into electric signals and detected. On the optical path between the collimator lens 117 and the composite optical element 118, a non-illustrated quarter-wave plate is provided that provides a phase difference of ¼ with respect to the wavelength of the light. Further, on the optical path, a non-illustrated aperture limitation element may be provided that controls the numerical aperture of the light beam of an angular wavelength incident on the composite optical element 118.

The light beam of the wavelength λ₂ emitted from the second laser light source 112 is deflected by the first beam splitter 114, straight travels through the second beam splitter 115 and the third beam splitter 116, is focused by the composite optical element 118 as an objective lens through the collimator lens 117, and is radiated to the optical disc 110. In this case, the optical disc 110 being read is a DVD as the second optical disc conforming to the light beam of the wavelength λ₂. Thereafter, the light beam reflected at the information recording surface of the optical disc 110 is transmitted by the composite optical element 118 and the collimator lens 117, is deflected by the third beam splitter 116, straight travels through the fourth beam splitter 119, is deflected by the fifth beam splitter 120, and is incident on the second photodetector 122 where the signals recorded on the information recording surface of the optical disc 110 are converted into electric signals and detected.

The light beam of the wavelength λ₃ emitted from the third laser light source 113 is deflected by the second beam splitter 115, straight travels through the third beam splitter 116, is focused by the composite optical element 118 as an objective lens through the collimator lens 117, and is radiated to the optical disc 110. In this case, the optical disc 110 being read is a CD as the third optical disc conforming to the light beam of the wavelength λ₃. Thereafter, the light beam reflected at the information recording surface of the optical disc 110 is transmitted by the composite optical element 118 and the collimator lens 117, is deflected by the third beam splitter 116, is further deflected by the fourth beam splitter 119, and is incident on the third photodetector 123 where the signals recorded on the information recording surface of the optical disc 110 are converted into electric signals and detected.

From the above, in the present embodiment, laser light sources of three different wavelengths, that is, the first laser light source 111 that emits the light beam of the wavelength λ₁, the second laser light source 112 that emits the light beam of the wavelength λ₂ and the third laser light source 113 that emits the light beam of the wavelength λ₃ are provided, and information recorded on the information recording surfaces of the optical disks conforming to the light beams emitted from the light sources can be detected.

### Eleventh Embodiment

Next, an eleventh embodiment will be described. The present embodiment is an optical head device having the composite optical element described in any of the first to ninth embodiments.

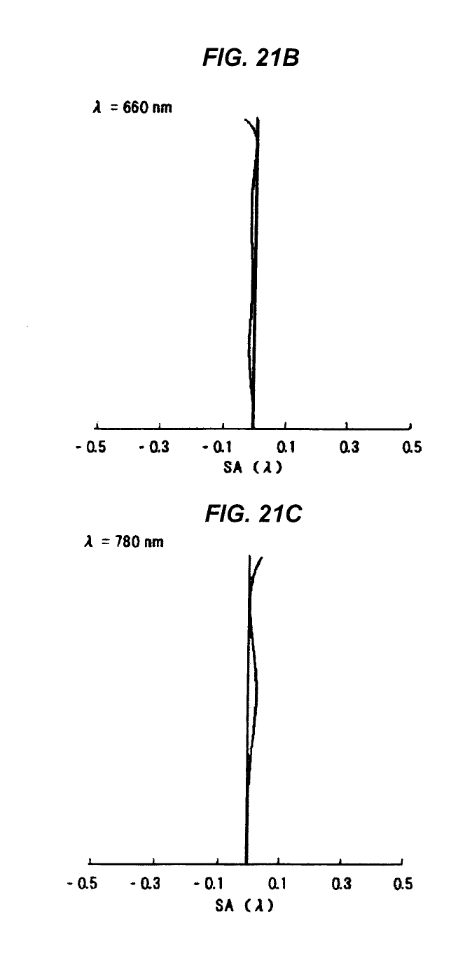

Based on FIG. 17, the optical head device according to the present embodiment will be described. The optical head device according to the present embodiment is an optical head device for performing recording and reading onto and from the optical disc 110, and is equipped for light beams of three different kinds of wavelengths. Specifically, it is equipped for, as the optical disc 110, three kinds of optical discs, the BD, the DVD and the CD which conform to the light beams of the 405-nm wavelength band, the 660-nm wavelength band and the 780-nm wavelength band, respectively.

The optical head device according to the present embodiment has: a first laser light source 131 that emits the light beam of the wavelength λ₁ which is the 405-nm wavelength band; a second laser light source 132 that emits the light beam of the wavelength λ₂ which is the 660-nm wavelength band and the light beam of the wavelength λ₃ which is the 780-nm wavelength band; a first beam splitter 133; a second beam splitter 134; a collimator lens 135; a composite optical element 136; and a photodetector 137. As these beam splitters, polarization beam splitters, dichroic beam splitters or the like are used.

As the composite optical element 136, the composite optical element described in any of the first to ninth embodiments that develops an objective lens function may be used. As the collimator lens 135, a non-illustrated stepping motor or the like is provided that is capable of adjusting the divergence angle of the light beam of each of the wavelengths incident on the composite optical element 136 by moving parallel to the optical axis. In the present embodiment, the light beam of the wavelength λ₁ emitted from the first laser light source 131 straight travels through the first beam splitter 133 and the second beam splitter 134, is focused by the composite optical element 136 as an objective lens through the collimator lens 135, and is radiated to the optical disc 110. In this case, the optical disc 110 being read is a BD as the first optical disc conforming to the light beam of the wavelength λ₁. Thereafter, the light beam reflected at the information recording surface of the optical disc 110 is transmitted by the composite optical element 136 and the collimator lens 135, is deflected by the second beam splitter 134, and is incident on the photodetector 137 where the signals recorded on the information recording surface of the optical disc 110 are converted into electric signals and detected.

The light beam of the wavelength λ₂ emitted from the second laser light source 132 is deflected by the first beam splitter 133, straight travels through the second beam splitter 134, is focused by the composite optical element 136 as an objective lens through the collimator lens 135, and is radiated to the optical disc 110. In this case, the optical disc 110 being read is a DVD as the second optical disc conforming to the light beam of the wavelength λ₂. Thereafter, the light beam reflected at the information recording surface of the optical disc 110 is transmitted by the composite optical element 136 and the collimator lens 135, is deflected by the second beam splitter 134, and is incident on the photodetector 137 where the signals recorded on the information recording surface of the optical disc 110 are converted into electric signals and detected.

The light beam of the wavelength λ₃ emitted from the third laser light source 132 is deflected by the first beam splitter 133, straight travels through the second beam splitter 134, is focused by the composite optical element 136 as an objective lens through the collimator lens 135, and is radiated to the optical disc 110. In this case, the optical disc 110 being read is a CD as the third optical disc conforming to the light beam of the wavelength λ₃. Thereafter, the light beam reflected at the information recording surface of the optical disc 110 is transmitted by the composite optical element 136 and the collimator lens 135, is deflected by the second beam splitter 134, and is incident on the photodetector 137 where the signals recorded on the information recording surface of the optical disc 110 are converted into electric signals and detected.

From the above, in the present embodiment, laser light sources of three different wavelengths, that is, the first laser light source 131 that emits the light beam of the wavelength λ₁ and the second laser light source 132 that emits the light beams of two wavelengths, the wavelength λ₂ and the light beam of the wavelength λ₃ are provided, and information recorded on the information recording surfaces of the optical disks conforming to the light sources can be detected. In particular, by adjusting the position of the collimator lens 135, the divergence angles of the light beams of the wavelengths incident on the composite optical element 136 are changed, and further, by adjusting the light focusing characteristic that the composite optical element 136 develops, the light beams of the wavelengths reflected at the optical disc 110 can be focused by one common photodetector 137. With this structure, the number of parts of the optical element can be reduced, so that a size reduction of the optical head device can be realized.

### EXAMPLES

### Example 1

Example 1 is based on the first embodiment. The composite optical element 10 according to the present example is designed as an element that focuses light beams of 405 nm as the wavelength λ₁, 660 nm as the wavelength λ₂ and 780 nm as the wavelength λ₃ on an optical disc. The numerical aperture and the diameter of the entrance pupil (unit, [mm]) at each of the wavelengths are shown in Table 1. In the examples, there are cases where the (air side) surface of the second resin layer 13 will be referred to as a first surface, the light beam incidence side surface of the single lens 11, as a second surface, and the light exit side surface of the composite optical element 10, as a third surface.

TABLE 1

| | Wavelength | | |
|---|---|---|---|
| | 405 nm | 660 nm | 780 nm |
| Entrance pupil diameter | 3.00 | 2.45 | 2.02 |
| Numerical aperture | 0.85 | 0.65 | 0.5 |

The composite optical element 10 of the present example is formed as follows: After the single lens 11 is formed so as to have a desired shape by the glass molding method, coupling processing is performed to enhance the adhesion to the first resin layer 12 formed on the glass surface. Thereafter, the first resin layer 12 is formed by the imprinting method. The first resin layer 12 is formed so that the surface thereof has a Fresnel lens configuration. Further, on the formed first resin layer 12, the second resin layer 13 is processed and formed by molding so as to have a desired configuration.

The refractive index of the first resin layer 12 and the refractive index of the second resin layer 13 are shown in Table 2. The diffraction grating of the blaze configuration formed on the first resin layer 12 so as to have a Fresnel lens configuration is formed so that the height h₁ is 25 μm with respect to a direction of travel of the light beam of the wavelength λ₂, that is, the light beam of 660 nm.

TABLE 2

| | Wavelength | | |
|---|---|---|---|
| | 405 nm | 660 nm | 780 nm |
| First resin layer | 1.555382 | 1.507765 | 1.501782 |
| Second resin layer | 1.555794 | 1.533637 | 1.529838 |

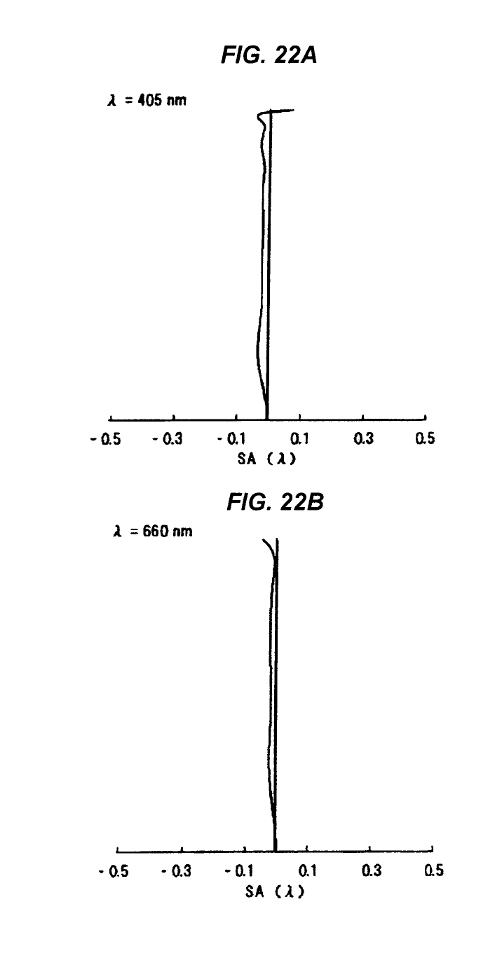

The diffraction efficiency η of the diffraction grating of the blaze configuration that is formed by the first resin layer 12 and the second resin layer 13 and the height h₁ of which is 25 μm is as shown in FIG. 18. That is, the light beam incident in the 405-nm wavelength band exits as a zero-order light beam without diffracted, and the light beams incident in the 660-nm wavelength band and in the 780-nm wavelength band exit with high diffraction efficiency of minus 1st order diffracted light. Here, η₀ indicates the zero-order diffraction efficiency, η₋₁ indicates the minus 1st order diffraction efficiency, and η₊₁ indicates the plus 1st order diffraction efficiency. The plus 1st order diffracted light is light diffracted so as to be focused in the direction of the optical axis, and the minus 1st order diffracted light is light diffracted so as to be focused in a direction opposite to the direction of the optical axis. In FIG. 18, η₊₁ is not shown since it is substantially zero.

The surfaces (the first to third surfaces) of the composite optical element 10 are aspherical, and are expressed by an expression shown at Expression 2. A fourth surface is the surface of the cover layer, and a fifth surface is the information recording surface.

$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16} \qquad [ Expression 2 ]$$

Here, the expression shown at Expression 2 represents the r dependence of the aspherical configuration when the direction of the optical axis is z, the distance from the optical axis within a plane vertical to the optical axis is r [mm] and the point at which the surfaces of the composite optical element 10 intersect the optical axis is z=0. c is the reciprocal of the radius of curvature of each vertex, k is the conic constant, and αᵢ (ᵢ=1 to 8) is the aspherical coefficient.

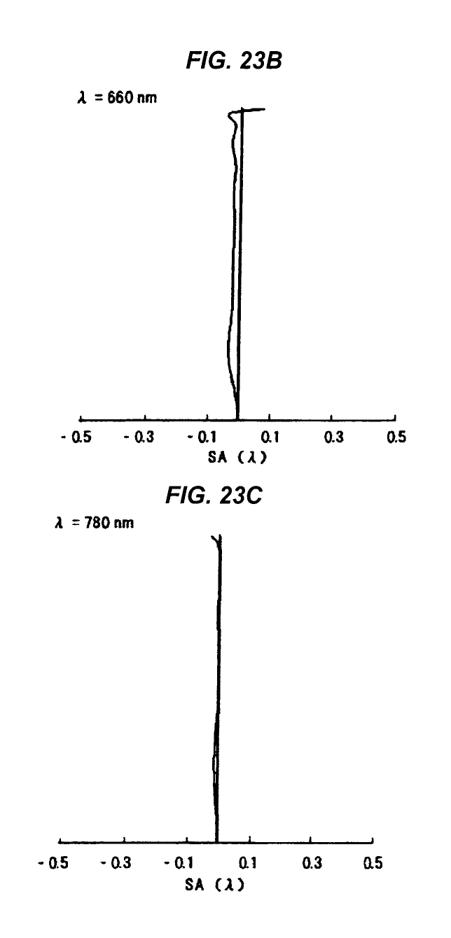

Table 3 shows the radii of curvature (unit, [mm]) of the surfaces of the composite optical element 10, the axial distances (the distances between the surfaces on the optical axis, unit, [mm]) and the refractive indices of the materials which the surfaces are formed of. Table 4 shows optical distances defined below (unit, [mm]) for the light beams of the wavelengths. As shown in FIG. 20, L1 represents the distance from a virtual light source 151 via a collimator lens 152 to the composite optical element 10, L2 represents the distance from the composite optical element 10 to a cover layer 153 of each optical disc, and L3 represents the thickness of the cover layer 153 of each optical disc. The thickness of the single lens 11 on the optical axis in the composite optical element 10 is 1.757 mm, and the distance between the second resin layer 13 and the single lens 11 on the optical axis is set to 0.04 mm. The cover layers of the optical discs corresponding to L3 shown in Table 4 conform to the BD (405 nm), the DVD (660 nm) and the CD (780 nm), respectively.

TABLE 3

| | Radius of | Axial | | | |
|---|---|---|---|---|---|
| | curvature | distance | Refractive index | | |
| Surface | (mm) | (mm) | 405 nm | 660 nm | 780 nm |
| | | L1 | | | |
| 1 | 1.177233 | 0.04 | 1.555794 | 1.533637 | 1.529838 |
| 2 | 1.177233 | 1.757473 | 1.599637 | 1.579996 | 1.576415 |
| 3 | −4.410797 | L2 | | | |
| 4 | ∞ | L3 | 1.622308 | 1.579613 | 1.573456 |
| 5 | ∞ | | | | |

TABLE 4

| | Wavelength | | |
|---|---|---|---|
| | 405 nm | 660 nm | 780 nm |
| L1 | ∞ | −37.460 | ∞ |
| L2 | 0.7 | 0.525 | 0.3 |
| L3 | 0.1 | 0.6 | 1.2 |

The conic constants and the aspherical coefficients of the first surface (the surface of the second resin layer 13 from the direction of the optical axis) and the second surface (the surface of the single lens 11 from the direction of the optical axis) are the same values and are the following values:

k=−0.638656713

α₁=0.0

α₂=1.563195E−2

α₃=−1.082702E−2

α₄=2.860841E−2

α₅=−2.971487E−2

α₆=1.883752E−2

α₇=−6.176390E−3

α₈=7.951991E−4

The conic constants and the aspherical coefficients of the third surface (the light exit surface of the single lens 11) are the following values:

k=−39.76454404

α₁=0.0

α₂=1.309717E−1

α₃=−1.219434E−1

α₄=5.463863E−2

α₅=−8.999275E−3

α₆=−3.311178E−4

α₇=0

α₈=0

By an expression shown at Expression 3, a change of the optical path by diffraction is expressed by a phase function φ(r). Here, M is the diffraction order, Aᵢ (i is an integer equal to or more than one) and ρ are values of r standardized by 1 mm.

$$φ = M {\sum }_{i = 1}^{N} {A}_{i} {ρ}^{2 i} \qquad [ Expression 3 ]$$

In the expression shown at Expression 3, the value of M is 0 at a wavelength of 405 nm, and −1 at a wavelength of 660 nm and a wavelength of 780 nm. The configuration of the diffraction grating surface at the interface between the first resin layer 12 and the second resin layer 13 is set so that the values of A₁ to A₃ are as follows:

A₁=−279.6016

A₂=5.82717

A₃=6.83897

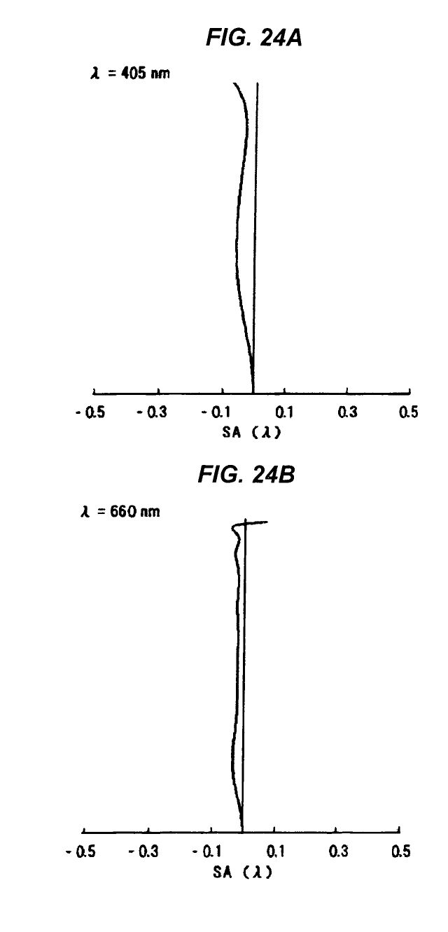

FIGS. 21A, 21B and 21C show graphic representations of spherical aberration SA for the light beams of the wavelengths. FIGS. 21A, 21B and 21C correspond to the light beam of 405 nm, the light beam of 660 nm and the light beam of 780 nm, respectively. The aberration at the point of focusing of the light beam of each wavelength exiting from the composite optical element 10 according to Example 1, that is, the position where the information recording surface of each optical disc is assumed is 21.2 mλrms at a wavelength of 405 nm, 6.2 mλrms at a wavelength of 660 nm and 9.4 mλrms at a wavelength of 780 nm, and the light beams can be excellently focused. As for the aberration, as long as it is 70 λrms or less, the light beams can be excellently focused.

### Example 2

In Example 2, a composite optical element in a case where the light beam of the wavelength λ₂, that is, the light beam of a wavelength of 660 nm is incident with an infinite system and the light beam of the wavelength λ₃, that is, the light beam of a wavelength of 780 nm is incident with a finite system is designed. Example 2 is different from Example 1 in the values of the entrance pupil diameter and the axial distances L1 and L2 and the value of the phase function of the second surface. Table 5 shows the values (unit, [mm]) of the entrance pupil diameter and the axial distances L1 and L2.

TABLE 5

| | Wavelength | | |
|---|---|---|---|
| | 405 nm | 660 nm | 780 nm |
| Entrance pupil diameter | 3.00 | 2.43 | 1.98 |
| L1 | ∞ | ∞ | 38.73989 |
| L2 | 0.7 | 0.544 | 0.3 |

In the expression shown at Expression 3, the value of M is 0 at a wavelength of 405 nm, and −1 at a wavelength of 660 nm and a wavelength of 780 nm. The configuration of the diffraction grating surface at the interface between the first resin layer 12 and the second resin layer 13 is set so that the values of A₁ to A₃ are as follows:

A₁=−173.7479582

A₂=5.856708628

A₃=5.507469245

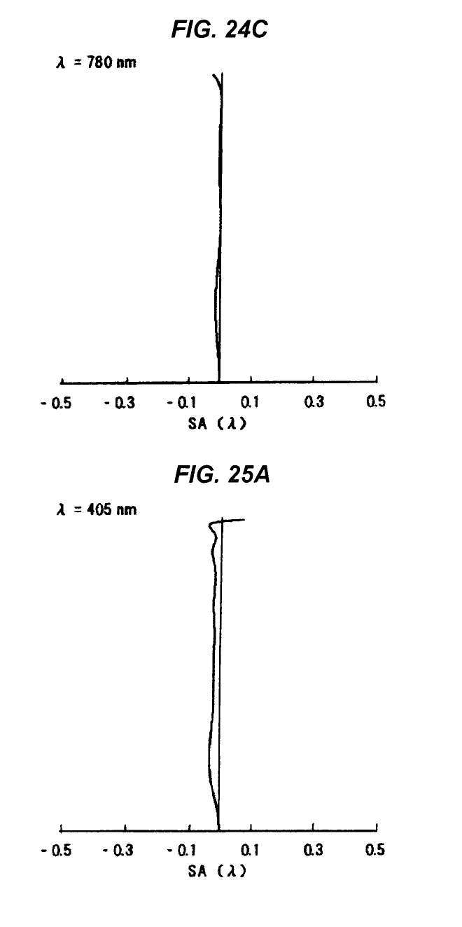

FIGS. 22A, 22B and 22C show graphic representations of spherical aberration SA for the light beams of the wavelengths. FIGS. 22A, 22B and 22C correspond to the light beam of 405 nm, the light beam of 660 nm and the light beam of 780 nm, respectively. The aberration at the point of focusing of the light beam of each wavelength exiting from the composite optical element 10 according to Example 2, that is, the position where the information recording surface of each optical disc is assumed is 21.2 mλrms at a wavelength of 405 nm, 6.3 mλrms at a wavelength of 660 nm and 6.5 mλrms at a wavelength of 780 nm, and the light beams can be excellently focused. Other conditions and the like are similar to those of Example 1.

### Example 3

Example 3 is a composite optical element 10 in which the light beam of the wavelength λ₂, that is, the light beam of a wavelength of 660 nm and the light beam of the wavelength λ₃, that is, the light beam of a wavelength of 780 nm are both incident with a finite system. Example 3 is different from Example 1 in the values of the entrance pupil diameter and the axial distances L1 and L2 and the value of the phase function of the second surface. Table 6 shows the values (unit, [mm]) of the entrance pupil diameter and the axial distances L and L2.

TABLE 6

| | Wavelength | | |
|---|---|---|---|
| | 405 nm | 660 nm | 780 nm |
| Entrance pupil diameter | 3.00 | 2.44 | 1.99 |
| L1 | ∞ | −74.8551 | 75 |
| L2 | 0.7 | 0.533 | 0.3 |

In the expression shown at Expression 3, the value of M is 0 at a wavelength of 405 nm, and −1 at a wavelength of 660 nm and a wavelength of 780 nm. The configuration of the diffraction grating surface at the interface between the first resin layer 12 and the second resin layer 13 is set so that the values of A₁ to A₃ are as follows:

A₁=−224.8858698

A₂=5.821827362

A₃=6.308923842

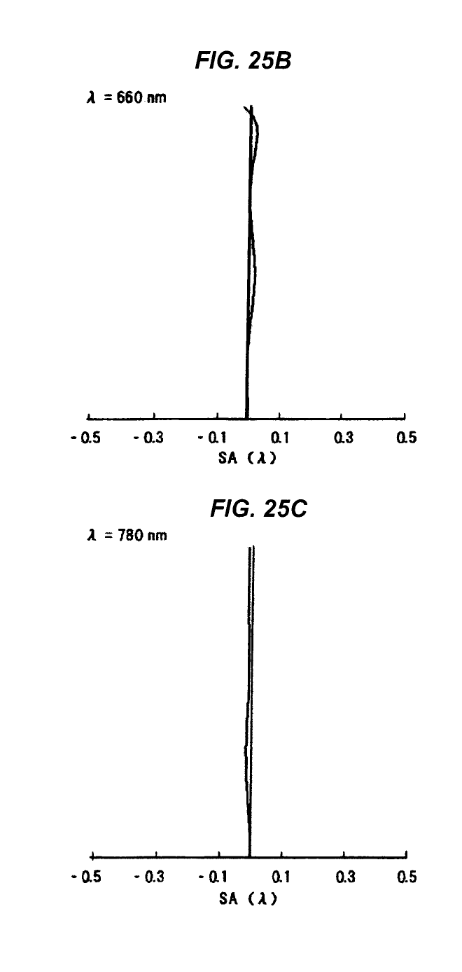

FIGS. 23A, 23B and 23C show graphic representations of spherical aberration SA for the light beams of the wavelengths. FIGS. 23A, 23B and 23C correspond to the light beam of 405 nm, the light beam of 660 nm and the light beam of 780 nm, respectively. The aberration at the point of focusing of the light beam of each wavelength exiting from the composite optical element 10 according to Example 3, that is, the position where the information recording surface of each optical disc is assumed is 21.2 mλrms at a wavelength of 405 nm, 5.9 mλrms at a wavelength of 660 nm and 8.8 mλrms at a wavelength of 780 nm, and the light beams can be excellently focused. Other conditions and the like are similar to those of Example 1.

### Example 4

A composite optical element according to Example 4 is based on the second embodiment. Specifically, it is the composite optical element 20 in which a phase level difference structure is formed on the surface of the second resin layer 23 and the light beam of the wavelength λ₂, that is, the light beam of a wavelength of 660 nm and the light beam of the wavelength λ₃, that is, the light beam of a wavelength of 780 nm are both incident with an infinite system. The single lens 21 is the same as the single lens 11 in Example 1. Table 7 shows the values (unit, [mm]) of the entrance pupil diameter and the axial distances L1 and L2 in the present example.

TABLE 7

| | Wavelength | | |
|---|---|---|---|
| | 405 nm | 660 nm | 780 nm |
| Entrance pupil diameter | 3.00 | 2.51 | 2.00 |
| L1 | ∞ | ∞ | ∞ |
| L2 | 0.7 | 0.619 | 0.3 |

In the expression shown at Expression 3, the value of M is 0 at a wavelength of 405 nm, and −1 at a wavelength of 660 nm and a wavelength of 780 nm. The configuration of the diffraction grating surface at the interface between the first resin layer 22 and the second resin layer 23 is set so that the values of A₁ to A₃ are as follows:

A₁=−283.8906959

A₂=16.8274628

A₃=−0.6609704

By setting the level difference d₂ formed on the surface of the second resin layer 23 to 1.457 μm, the values of the phase difference Δn(λ)d₂/λ (λ is the wavelength) caused by the refractive index Δn(λ) of air and the second resin layer 23 in the light beams of wavelengths of 405 nm, 660 nm and 780 nm can be made 2, 1.18 and 0.99, respectively. That is, when the light beam of a wavelength of 405 nm and the light beam of a wavelength of 780 nm are incident, since the phase difference is substantially an integral multiple of the wavelength, there is no influence of the phase difference; however, when the light beam of a wavelength of 660 nm is incident, since the phase difference is not substantially an integral multiple of the wavelength, there is an influence of the phase difference.

In this case, the configuration of the phase level difference of the interface between air and the second resin layer 23 is processed so that the coefficients are the following values:

A₁=−13.30723534

A₂=13.30723534

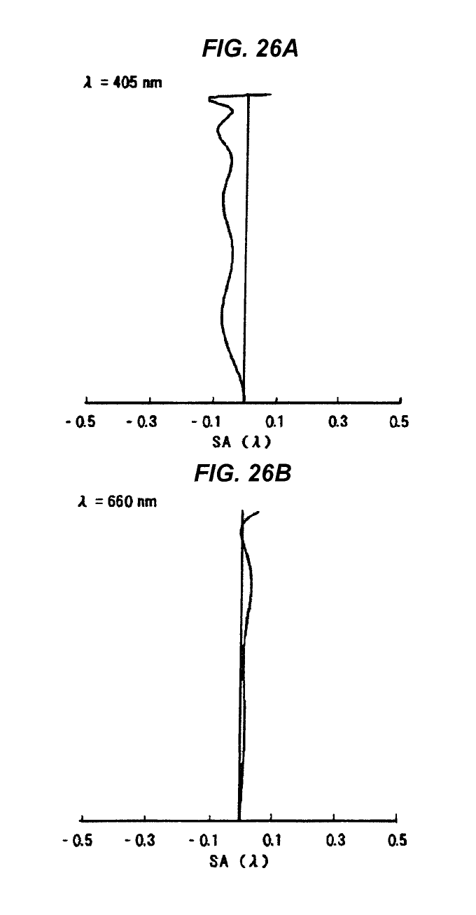

FIGS. 24A, 24B and 24C show graphic representations of spherical aberration SA for the light beams of the wavelengths. FIGS. 24A, 24B and 24C correspond to the light beam of 405 nm, the light beam of 660 nm and the light beam of 780 nm, respectively. By the above, in the composite optical element 20 according to Example 4, the light beams can be excellently focused at the wavelengths. Other conditions and the like are similar to those of Example 1.

### Example 5

A composite optical element according to Example 5 is based on the third embodiment. Specifically, it is the composite optical element 40 in which a diffraction grating having a Fresnel lens configuration is formed on the interface between the first resin layer 42 and the second resin layer 43 and the (air side) surface of the second resin layer 43 and the light beam of the wavelength λ₂, that is, the light beam of a wavelength of 660 nm and the light beam of the wavelength λ₃, that is, the light beam of a wavelength of 780 nm are both incident with an infinite system. The single lens 41 is the same as the single lens 11 in Example 1. Table 8 shows the values (unit, [mm]) of the entrance pupil diameter and the axial distances L1 and L2 in the present example.

TABLE 8

| | Wavelength | | |
|---|---|---|---|
| | 405 nm | 660 nm | 780 nm |
| Entrance pupil diameter | 3.00 | 2.32 | 2.00 |
| L1 | ∞ | ∞ | ∞ |
| L2 | 0.7 | 0.450 | 0.3 |

In the expression shown at Expression 3, the value of M is 0 at a wavelength of 405 nm, and −1 at a wavelength of 660 nm and a wavelength of 780 nm. The configuration of the diffraction grating surface at the interface between the first resin layer 42 and the second resin layer 43 is set so that the values of A₁ to A₃ are as follows:

A₁=−281.4348109

A₂=10.5725758

A₃=3.58148074

By making the level difference d₃₅ formed on the surface of the second resin layer 43 a pseudo blaze where the number of steps of 1.457 μm is five, the values of the phase difference Δnd_{3S}/λ (λ is the wavelength) caused by the refractive index Δn of air and the second resin layer 23 in wavelengths of 405 nm, 660 nm and 780 nm can be made 2, 1.18 and 0.99, respectively. When the light beam of a wavelength of 405 nm and the light beam of a wavelength of 780 nm are incident, since the phase difference is substantially an integral multiple of the wavelength, the light beams are not diffracted; however, when the light beam of a wavelength of 660 nm is incident, since the phase difference is not substantially an integral multiple of the wavelength, the light beam is diffracted.

In this case, the configuration of the diffraction grating surface of the interface between air and the second resin layer 43 is processed so that the coefficients are the following values:

A₁=−232.61692015

A₂=−3.10648414

A₃=−9.08156951

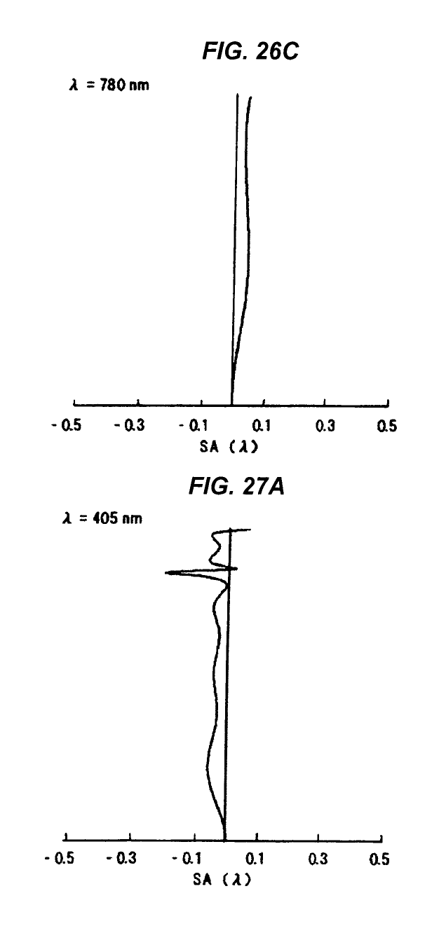

FIGS. 25A, 25B and 25C show graphic representations of spherical aberration SA for the light beams of the wavelengths. FIGS. 25A, 25B and 25C correspond to the light beam of 405 nm, the light beam of 660 nm and the light beam of 780 nm, respectively. The aberration at the point of focusing of the light beam of each wavelength exiting from the composite optical element 40 according to Example 5, that is, the position where the information recording surface of each optical disc is assumed is 21.2 mλrms at a wavelength of 405 nm, 8.4 mλrms at a wavelength of 660 nm and 2.5 mλrms at a wavelength of 780 nm, and the light beams can be excellently focused. Other conditions and the like are similar to those of Example 1.

### Example 6

A composite optical element according to Example 6 is based on the fourth embodiment. Specifically, it is the composite optical element 50 in which a diffraction structure is formed in the peripheral region of the surface of the second resin layer 53 and a function is provided of limiting the diameter where the light beam of the wavelength λ₃ is incident so that the numerical aperture of the light beam of the wavelength λ₃, that is, the light beam of a wavelength of 780 nm is a predetermined value. The single lens 51 is the same as the single lens 11 in Example 1.

A binary diffraction grating where the value of the height d₄ is 3.65 μm is formed in the peripheral region of the second resin layer 53. By forming such a binary diffraction grating, the values of the phase difference Δn(λ)d₄/λ (λ is the wavelength) caused by the refractive index Δn(λ) of air and the second resin layer 23 at wavelengths of 405 nm, 660 nm and 780 nm can be made 5.0, 3.0 and 2.5, respectively. When the light beam of a wavelength of 405 nm and the light beam of a wavelength of 660 nm are incident, since the phase difference is substantially an integral multiple of the wavelength, the light beams are not diffracted; however, when the light beam of a wavelength of 780 nm is incident, since the phase difference is not substantially an integral multiple of the wavelength, the light beam is diffracted, and the light beam in the region where the binary diffraction grating is formed is substantially not straight transmitted.

By the above, in the composite optical element 50 according to Example 6, the light beams can be excellently focused at the wavelengths. Moreover, the incidence diameter of the light beam of a wavelength of 780 nm can be limited. Other conditions and the like are similar to those of Example 1.

### Example 7

A composite optical element according to Example 7 is based on the fifth embodiment. Specifically, it is the composite optical element 60 in which a phase level difference is formed in the peripheral region of the surface of the second resin layer 63 and a function is provided of limiting the diameter where the light beam of the wavelength λ₃ is incident so that the numerical aperture of the light beam of the wavelength λ₃, that is, the light beam of a wavelength of 780 nm is a predetermined value. The single lens 61 is the same as the single lens 11 in Example 1.

A groove where the value of the level difference d₅ is 3.65 μm is formed in the peripheral region of the second resin layer 63. By forming such a groove, the values of the phase difference Δn(λ)d₅/λ (λ is the wavelength) caused by the refractive index Δn(λ) of air and the second resin layer 63 at wavelengths of 405 nm, 660 nm and 780 nm can be made 5.0, 3.0 and 2.5, respectively. When the light beam of a wavelength of 405 nm and the light beam of a wavelength of 660 nm are incident, since the phase difference is substantially an integral multiple of the wavelength, the light beams not undergo a phase change; however, when the light beam of a wavelength of 780 nm is incident, since the phase difference is not substantially an integral multiple of the wavelength, the light beam undergoes a phase change and the light beam of a wavelength λ₃ incident on the region where the groove is formed is not excellently focused on the information recording surface 19b of the third optical disc 19, so that the size of the aperture is substantially limited.

By the above, in the composite optical element 60 according to Example 7, the light beams can be excellently focused at the wavelengths. Moreover, the incidence diameter of the light beam of a wavelength of 780 nm can be limited.

Other conditions and the like are similar to those of Example 1.

### Example 8

A composite optical element according to Example 8 is based on the seventh embodiment. The composite optical element 70 according to the present example is constituted by the single lens 71, the first resin layer 72 and the second resin layer 73, and a diffraction grating the cross sectional configuration of which is a blaze configuration is formed by the interface between the first resin layer 72 and the second resin layer 73.

Table 9, Table 10 and Table 11 show the values of the configuration, refractive index and the like of the composite optical element 70 according to the present example. In particular, Table 10 shows the values (unit, [mm]) of the entrance pupil diameter and the axial distances L1, L2 and L3 in the present example. First to third surfaces are the surfaces of the composite optical element 70, a fourth surface is the surface of the cover layer, and a fifth surface is the information recording surface.

TABLE 9

| | Radius of | Axial | | | |
|---|---|---|---|---|---|
| | curvature | distance | Refractive index | | |
| Surface | (mm) | (mm) | 405 nm | 660 nm | 780 nm |
| | | L1 | | | |
| 1 | 1.2397532 | 0.04 | 1.525099 | 1.506956 | 1.503724 |
| 2 | 1.2397532 | 1.70E+00 | 1.599637 | 1.579996 | 1.576415 |
| 3 | −4.410797 | L2 | | | |
| 4 | ∞ | L3 | 1.622308 | 1.579613 | 1.573456 |
| 5 | ∞ | | | | |

TABLE 10

| | Wavelength | | |
|---|---|---|---|
| | 405 nm | 660 nm | 780 nm |
| Entrance pupil diameter | 3.00 | 2.45 | 2.02 |
| L1 | ∞ | −148.273 | 28.5289 |
| L2 | 0.742868 | 0.516 | 0.3 |
| L3 | 0.1 | 0.6 | 1.2 |

TABLE 11

| | 1st surface | 2nd surface | 3rd surface |
|---|---|---|---|
| k | −5.167833E−01 | −5.167833E−01 | −3.976454E+01 |
| α₁ | 0 | 0 | 0 |
| α₂ | 6.053505E−03 | 6.053505E−03 | 1.309717E−01 |
| α₃ | 6.491001E−03 | 6.491001E−03 | −1.219434E−01 |
| α₄ | −1.048838E−03 | −1.048838E−03 | 5.463863E−02 |
| α₅ | −8.330428E−04 | −8.330428E−04 | −8.999275E−03 |
| α₆ | 1.664393E−03 | 1.664393E−03 | −3.311178E−04 |
| α₇ | −7.706654E−04 | −7.706654E−04 | 0 |
| α₈ | 1.680936E−04 | 1.680936E−04 | 0 |

Table 12 shows the refractive indices of the first resin layer 72 and the second resin layer 73. A diffraction grating is formed in which the interface between the first resin layer 72 and the second resin layer 73 has a blaze configuration where the height h₆ is 13.5 μm with respect to the direction of the light beam traveling through the first resin layer 72.

TABLE 12

| | Wavelength | | |
|---|---|---|---|
| | 405 nm | 660 nm | 780 nm |
| First resin layer | 1.5554 | 1.5078 | 1.5018 |
| Second resin layer | 1.5251 | 1.5070 | 1.5037 |

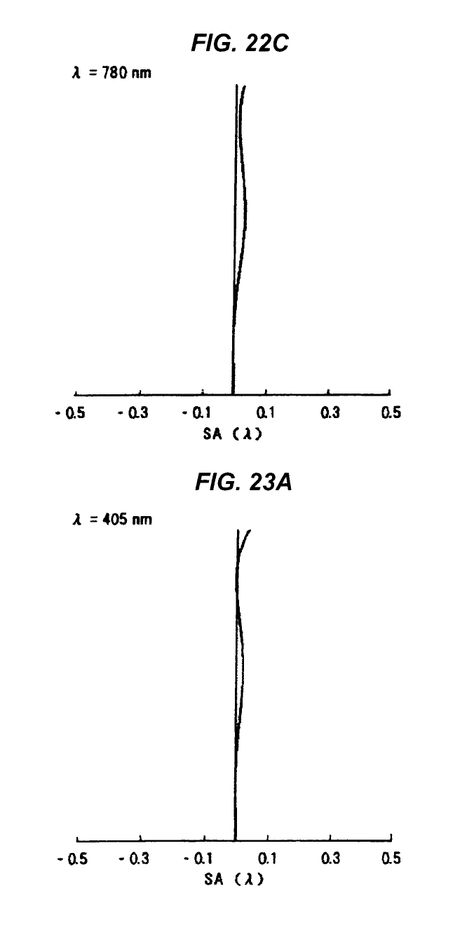

The diffraction efficiency η of the diffraction grating in the present example is that shown in FIG. 19. That is, the light beam incident in the 405-nm wavelength band is diffracted with a high diffraction efficiency (η₊₁) of the plus 1st order diffracted light, and the light beam in the 660-nm wavelength band and the light beam incident in the 780-nm wavelength band are transmitted without diffracted. Consequently, the light beams of the wavelengths can be efficiently used. In FIG. 18, η₋₁ is not shown since it is substantially zero.

In the expression shown at Expression 3, the value of M is 1 at a wavelength of 405 nm, and 0 at a wavelength of 660 nm and a wavelength of 780 nm. The coefficients of the phase function of the diffraction grating surface at the interface between the first resin layer 72 and the second resin layer 73 are as follows:

A₁=−175.0024593

A₂=−17.3941813

A₃=109.140934

A₄=−85.5726871

A₅=26.8307306

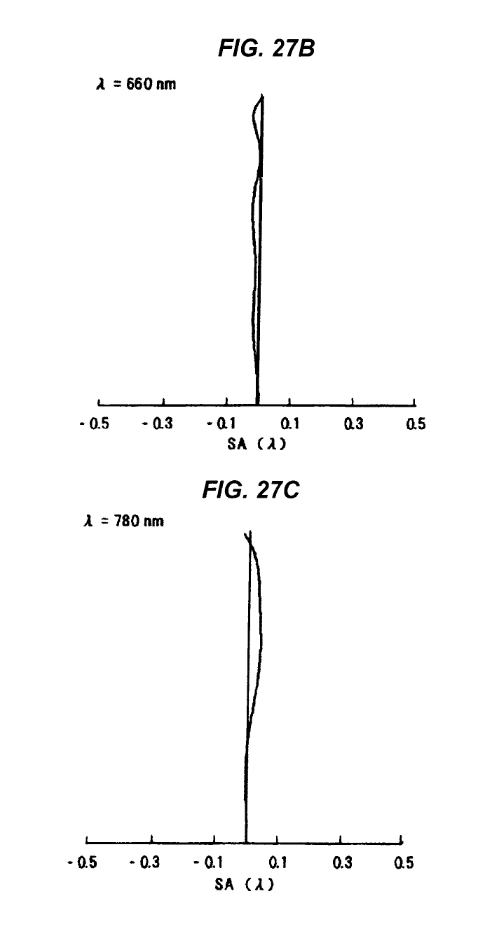

FIGS. 26A, 26B and 26C show graphic representations of spherical aberration SA for the light beams of the wavelengths. FIGS. 26A, 26B and 26C correspond to the light beam of 405 nm, the light beam of 660 nm and the light beam of 780 nm, respectively. The aberration at the point of focusing of the light beam of each wavelength exiting from the composite optical element 70 according to Example 8, that is, the position where the information recording surface of each optical disc is assumed is 20.9 mλrms at a wavelength of 405 nm, 11.9 mλrms at a wavelength of 660 nm and 8.9 mλrms at a wavelength of 780 nm, and the light beams can be excellently focused.

### Example 9

A composite optical element according to Example 9 is based on the eighth embodiment. The composite optical element 80 according to the present example is constituted by the single lens 81, the first resin layer 82 and the second resin layer 83, and a diffraction grating the cross sectional configuration of which is a blaze configuration is formed in a part of the region (region including the optical axis) of the interface between the first resin layer 82 and the second resin layer 83. Specifically, the composite optical element 80 has the first region 7A in which a diffraction grating is formed by the interface between the first resin layer 82 and the second resin layer 83 and the second region 7B in which a diffraction grating is not formed thereby, and is formed so that an expression shown at Expression 4 holds within a range of r≦1.3 and that an expression shown at Expression 5 is satisfied within a range of r>1.3.

$$\begin{matrix}{z}_{1} = \frac{{c}_{1} {r}^{2}}{1 + \sqrt{1 - ( 1 + {k}_{1} ) {c}_{1}^{2} {r}^{2}}} + {\sum }_{i = 1}^{8} {α}_{1 i} {r}^{2 i} & [ Expression 4 ] \\ {z}_{2} = {z}_{0} + \frac{{c}_{2} {r}^{2}}{1 + \sqrt{1 - ( 1 + {k}_{2} ) {c}_{2}^{2} {r}^{2}}} + {\sum }_{i = 1}^{8} {α}_{2 i} {r}^{2 i} & [ Expression 5 ]\end{matrix}$$

Here, z₀ represents the difference z₀=z₁(1.3)−z₂′(1.3) in value where r=1.3 when the surface configuration when there is no z₀ is z₁(r) and z₂′(r). Table 13, Table 14 and Table 15 show the configuration and the refractive index of the composite optical element 80 according to the present example. In particular, Table 14 shows the values (unit, [mm]) of the entrance pupil diameter and the axial distances L1, L2 and L3 in the present example. The (air side) surface of the second resin layer 83 will be referred to as a first surface; the interface between the first resin layer 82 and the single lens 81, as a second surface; the light exit side surface of the composite optical element (single lens 81), as a third surface; the central region including the optical axis, as a first region; and the annular region that is present in the periphery of the first region, as a second region. A fourth surface is the surface of the cover layer, and a fifth layer is the information recording surface.

TABLE 13

| | Radius of | Radius of | Axial | | | |
|---|---|---|---|---|---|---|
| | curvature 1 | curvature 2 | distance | Refractive index | | |
| Surface | (mm) | (mm) | (mm) | 405 nm | 660 nm | 780 nm |
| | | | L1 | | | |
| 1 | 1.24E+00 | 2.21E+00 | 4.00E−02 | 1.525099 | 1.506956 | 1.503724 |
| 2 | 1.24E+00 | 2.21E+00 | 1.74E+00 | 1.599637 | 1.579996 | 1.576415 |
| 3 | −4.94E+00 | | L2 | | | |
| 4 | ∞ | | L3 | 1.622308 | 1.579613 | 1.573456 |
| 5 | ∞ | | | | | |

TABLE 14

| | Wavelength | | |
|---|---|---|---|
| | 405 nm | 660 nm | 780 nm |
| Entrance pupil diameter | 3.00 | 2.42 | 1.97 |
| L1 | ∞ | ∞ | 27.48756 |
| L2 | 0.7 | 0.530022 | 0.3 |
| L3 | 0.0875 | 0.6 | 1.2 |

TABLE 15

| | 1st surface | 1st surface | 2nd surface | 2nd surface | |
|---|---|---|---|---|---|
| | 1st region | 2nd region | 1st region | 2nd resion | 3rd surface |
| k | −7.005571E−01 | −1.993780E−01 | −7.005571E−01 | −1.993780E−01 | −3.282262E+00 |
| α₁ | 0 | 0 | 0 | 0 | 0 |
| α₂ | 2.112110E−02 | 1.457418E−03 | 2.112110E−02 | 1.457418E−03 | 1.374404E−01 |
| α₃ | −5.685809E−03 | 6.097773E−02 | −5.685809E−03 | 6.097773E−02 | −5.859392E−02 |
| α₄ | 1.469420E−02 | 7.575594E−03 | 1.469420E−02 | 7.575594E−03 | −2.863478E−02 |
| α₅ | 1.456893E−03 | −4.296919E−03 | 1.456893E−03 | −4.296919E−03 | 3.290110E−02 |
| α₆ | −1.309836E−02 | −1.713527E−03 | −1.309836E−02 | −1.713527E−03 | −8.009095E−03 |
| α₇ | 9.560925E−03 | −1.115996E−04 | 9.560925E−03 | −1.115996E−04 | 0 |
| α₈ | −2.157703E−03 | 2.097861E−04 | −2.157703E−03 | 2.097861E−04 | 0 |

In the expression shown at Expression 3, the value of M is 1 at a wavelength of 405 nm, and 0 at a wavelength of 660 nm and a wavelength of 780 nm. The coefficients of the phase relationship of the diffraction grating formed only in the first region 7A at the interface between the first resin layer 82 and the second resin layer 83 are the following values:

A₁=−436.590796

A₂=−30.22682545

A₃=250.5501439

A₄=−242.3786543

A₅=108.1249459

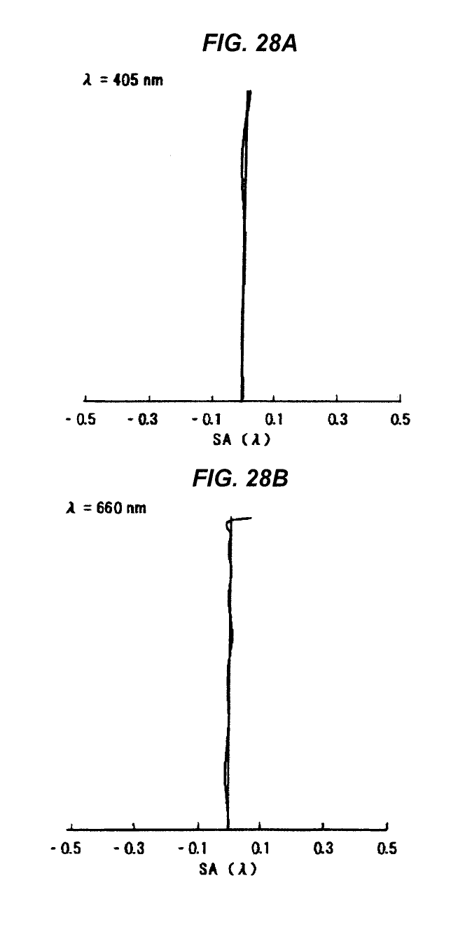

FIGS. 27A, 27B and 27C show graphic representations of spherical aberration SA for the light beams of the wavelengths. FIGS. 27A, 27B and 27C correspond to the light beam of 405 nm, the light beam of 660 nm and the light beam of 780 nm, respectively. The aberration at the point of focusing of the light beam of each wavelength exiting from the composite optical element 80 according to Example 9, that is, the position where the information recording surface of each optical disc is assumed is 40.3 rλrms at a wavelength of 405 nm, 7.7 mλrms at a wavelength of 660 nm and 4.5 mλrms at a wavelength of 780 nm, and the light beams can be excellently focused. Other conditions and the like are similar to those of Example 8.

### Example 10

A composite optical element according to Example 10 is based on the ninth embodiment. The composite optical element 90 according to the present example is constituted by the single lens 91, the first resin layer 92, the second resin layer 93 and further, the protective layer 94. At the interface between the first resin layer 92 and the second resin layer 93, a diffraction grating the cross-sectional configuration of which is a blaze configuration is formed, and the surface where the single lens 91 and the first resin layer 92 are in contact with each other and the surface where the second resin layer 93 and the protective layer 94 are in contact with each other are spherical.

Table 16, Table 17 and Table 18 show the configuration and the refractive index of the composite optical element 90 according to the present example. In particular, Table 17 shows the values (unit, [mm]) of the entrance pupil diameter and the axial distances L1, L2 and L3 in the present example. The (air side) surface of the protective layer 94 is referred to as a first surface; the interface between the protective layer 94 and the second resin layer 93, as a second surface; the interface between the first resin layer 92 and the single lens 91, as a third surface; and the light exit side surface of the composite optical element (single lens 91), as a fourth surface. A fifth surface is the surface of the cover surface, and a sixth surface is the information recording surface.

TABLE 16

| | Radius of | Axial | | | |
|---|---|---|---|---|---|
| | curvature 1 | distance | Refractive index | | |
| Surface | (mm) | (mm) | 405 nm | 660 nm | 780 nm |
| | | L1 | | | |
| 1 | 1.27E+00 | 5.00E−01 | 1.841127 | 1.799909 | 1.793089 |
| 2 | 1.50E+00 | 4.00E−02 | 1.555794 | 1.533637 | 1.529838 |
| 3 | 1.50E+00 | 1.14E+00 | 1.599637 | 1.579996 | 1.576415 |
| 4 | −7.46E+00 | L2 | | | |
| 5 | ∞ | L3 | 1.622308 | 1.579613 | 1.573456 |
| 6 | ∞ | | | | |

TABLE 17

| | Wavelength | | |
|---|---|---|---|
| | 405 nm | 660 nm | 780 nm |
| Entrance pupil diameter | 3.00 | 2.46 | 2.01 |
| L1 | ∞ | −5.83E+01 | ∞ |
| L2 | 7.00E−01 | 5.58E−01 | 3.00E−01 |
| L3 | 0.0875 | 0.6 | 1.2 |

TABLE 18

| | 1st surface | 4th surface |
|---|---|---|
| k | −0.615506505 | −10.35279107 |
| α₁ | 0 | 0 |
| α₂ | 0.017365902 | 0.147522458 |
| α₃ | −0.006535879 | −0.178950646 |
| α₄ | 0.025027607 | 0.10759781 |
| α₅ | −0.028153281 | −0.033306217 |
| α₆ | 0.018616288 | 0.004132273 |
| α₇ | −0.006218606 | 0 |
| α₈ | 0.000774416 | 0 |

Table 19 shows the refractive indices of the light beams of the wavelengths at the first resin layer 92 and the second resin layer 93.

TABLE 19

| | Wavelength | | |
|---|---|---|---|
| | 405 nm | 660 nm | 780 nm |
| First resin layer | 1.5554 | 1.5078 | 1.5018 |
| Second resin layer | 1.5558 | 1.5336 | 1.5298 |

The interface between the first resin layer 92 and the second resin layer 93 forms a diffraction grating of a blaze configuration where the height h₈ is 25 μm with respect to the direction of the light beam traveling through the first resin layer 92. In the expression shown at Expression 3, the value of M is −1 at a wavelength of 405 nm, and 0 at a wavelength of 660 nm and a wavelength of 780 nm. Thereby, when the light beam of a wavelength of 405 nm is incident, the refractive index is high, and when the light beams of wavelengths of 660 nm and 780 nm are incident, the light beams can be efficiently diffracted with a high minus 1st order diffraction efficiency. The coefficients of the phase relationship are the following values:

A₁=−371.1647158

A₂=52.6764996

A₃=0.2249316

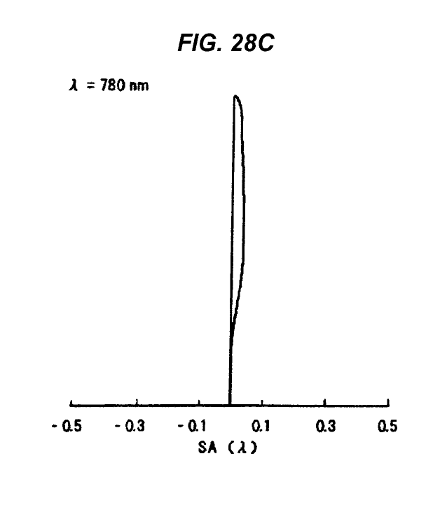

FIGS. 28A, 28B and 28C show graphic representations of spherical aberration SA for the light beams of the wavelengths. FIGS. 28A, 28B and 28C correspond to the light beam of 405 nm, the light beam of 660 nm and the light beam of 780 nm, respectively. The aberration at the point of focusing of the light beam of each wavelength exiting from the composite optical element 90 according to Example 10, that is, the position where the information recording surface of each optical disc is assumed is 14.9 mλrms at a wavelength of 405 nm, 7.0 mλrms at a wavelength of 660 nm and 6.0 mλrms at a wavelength of 780 nm, and the light beams can be excellently focused.

While the present application has been described in detail with reference to specific embodiments, it is obvious to one of ordinary skill in the art that various changes and modifications may be made without departing from the spirit and scope of the invention.

The present application is based on Japanese Patent Application (Patent Application No. 2009-164240) filed on Jul. 10, 2009, the contents of which are incorporated herein by reference.

### DESCRIPTION OF REFERENCE NUMERALS

10 Composite optical element
11 Single lens
12 First resin layer
12a Refractive index characteristic at the first resin
layer
13 Second resin layer
13a Refractive index characteristic at the second
resin layer
14 Light beam of the wavelength λ₁
15 Light beam of the wavelength λ₂
16 Light beam of the wavelength λ₃
17 First optical disc
17a Cover layer
17b Information recording surface
18 Second optical disc
18a Cover layer
18b Information recording surface
19 Third optical disc
19a Cover layer
19b Information recording surface
110 Optical disc
111 First laser light source
112 Second laser light source
113 Third laser light source
114 First beam splitter
115 Second beam splitter
116 Third beam splitter
117 Collimator lens
118 Composite optical element (objective lens)
119 Fourth beam splitter
120 Fifth beam splitter
121 First photodetector
122 Second photodetector
123 Third photodetector

1. A composite optical element comprising:
a single lens having a curved surface shape and acting optically;
a first resin layer formed on a surface of the single lens; and
a second resin layer formed on the first resin layer, wherein:
the first resin layer has a diffraction grating of a Fresnel lens configuration on a side of the second resin layer; and
a refractive index of the first resin layer and a refractive index of the second layer are substantially the same value for at least a light beam of one of a light beam of a wavelength λ₁, a light beam of a wavelength λ₂ and a light beam of a wavelength λ₃ (λ₁<λ₂<λ₃) and the refractive index of the first resin layer and the refractive index of the second resin layer are different values for at least a light beam of another one of the light beam of the wavelength λ₁, the light beam of the wavelength λ₂ and the light beam of the wavelength λ₃.

2. The composite optical element according to claim 1, wherein
the second resin layer has a diffraction grating of a Fresnel lens configuration on a surface on a side facing a side of the first resin layer.

3. The composite optical element according to claim 2, wherein:
the diffraction grating formed on the surface of the second resin layer on the side facing the side of the first resin layer has a step-like pseudo blaze configuration where the blaze configuration is approximated to a plurality of level differences; and
the level differences provide a phase difference which is substantially an integral multiple of one kind of the three kinds of wavelengths of the light beams or provide a phase difference which is substantially an integral multiple at two kinds of the three kinds of wavelengths of the light beams.

4. The composite optical element according to claim 1, wherein:
the second resin layer has a central region with a center at an optical axis and an annular peripheral region surrounding the central region on the surface on the side facing the side of the first resin layer;
the central region has a curved surface shape; and
the peripheral region has a phase level difference or a binary diffraction grating for a curved surface of the central region.

5. The composite optical element according to claim 4, wherein:
the peripheral region has the phase level difference;
the phase level difference has a plurality of level differences; and
the level differences provide a phase difference which is substantially an integral multiple of one kind of the three kinds of wavelengths of the light beams or provide a phase difference which is substantially an integral multiple of each of two kinds of the three kinds of wavelengths of the light beams.

6. The composite optical element according to claim 4, wherein:
the peripheral region has the phase level difference;
the phase level difference consists of one level difference; and
the level difference provides a phase difference substantially equal to an odd multiple of λ₃/2 for the light beam of the wavelength λ₃ and provides a phase difference substantially equal to substantially an integral multiple at each wavelength for the light beam of the wavelength λ₁ and the light beam of the wavelength λ₂.

7. The composite optical element according to claim 4, wherein:
the peripheral region has the binary diffraction grating; and
a depth of the binary diffraction grating is a value that provides a phase difference substantially equal to an odd multiple of λ₃/2 for the light beam of the wavelength λ₃ and provides a phase difference substantially equal to an integral multiple of each wavelength for the light beam of the wavelength λ₁ and the light beam of the wavelength λ₂.

8. The composite optical element according to claim 1, wherein:
the first resin layer has an inner central region with a center at an optical axis and an annular inner peripheral region surrounding the inner central region on the side of the second resin layer;
the inner central region has the diffraction grating of the Fresnel lens configuration; and
the inner peripheral region has a curved surface shape.

9. The composite optical element according to claim 1, wherein
a protective layer is formed on the second resin layer.

10. The composite optical element according to claim 1, wherein
the wavelength λ₁ is a 405-nm wavelength band of 375 to 435 nm, the wavelength λ₂ is a 660-nm wavelength band of 630 to 690 nm, and the wavelength λ₃ is a 780-nm wavelength band of 750 to 810 nm.

11. An optical head device comprising:
a light source that emits a light beam of a 405-nm wavelength band, a light beam of a 660-nm wavelength band and a light beam of a 780-nm wavelength band;
the composite optical element according to any one of claims 1 to 10 that condenses the light beam of each of the wavelength bands emitted from the light source, on an information recording surface of an optical disc conforming to the light beam of the wavelength band; and
a photodetector for detecting a signal light beam reflected at the information recording surface of the optical disc.
